(19) United States
(12) Patent Application Publication
(10) Pub. No.: US 2018/0237629 A1
(43) Pub. Date: Aug. 23, 2018

(54) CURABLE COMPOSITION

(71) Applicant: TOAGOSEI CO., LTD., Tokyo (JP)

(72) Inventors: Kentaro YACHI, Nagoya-shi, Aichi (JP); Naoki HASHIMOTO, Nagoya-shi, Aichi (JP)

(73) Assignee: TOAGOSEI CO., LTD., Tokyo (JP)

(21) Appl. No.: 15/753,308

(22) PCT Filed: Aug. 9, 2016
(86) PCT No.: PCT/JP2016/073378

§ 371 Date: Feb. 17, 2018

(30) Foreign Application Priority Data
Aug. 21, 2015 (JP) 2015-164092

(51) Int. Cl. C08L 33/08; C08F 290/06; C08L 33/10; C08L 75/16; C08L 63/00; C08L 67/07; C08F 2/48; C08K 5/103

(52) U.S. Cl. CPC C08L 33/08; C08F 290/06; C08L 33/10; C08K 5/103; C08L 63/00; C08L 67/07; C08F 2/48; C08L 75/16

(57) ABSTRACT

A curable composition, which has low viscosity and is excellent in terms of appearance and hardness of a cured product, and preferably an active energy beam-curable composition are provided.

The curable composition includes the following components (A) and (B),
component (A): a (meth)acrylate mixture including glycerin tri(meth)acrylate as a main component, the mixture including a high-molecular-weight body, for which an area percent (%) is defined by a specific equation and is a value obtained in accordance with gel permeation chromatography measurement, is less than 30%; and
component (B): an oligomer having two or more (meth)acryloyl groups, a reaction product of an organic polyisocyanate and a hydroxy group-containing (meth)acrylate, or a combination thereof.

### TECHNICAL FIELD

The present invention relates to a curable composition and preferably relates to an active energy beam-curable composition, which can be used for various purposes, such as coating agents, ink, molding materials, and, in particular, can be preferably used for coating, such as plastic paints or wood paints. The present invention belongs to these technical fields.

Herein, the term “acryloyl group and/or methacryloyl group” is expressed as a “(meth)acryloyl group”, the term “acrylate and/or methacrylate” is expressed as a “(meth)acrylate”, and the term “acrylic acid and/or methacrylic acid” is expressed as a “(meth)acrylic acid”.

### RELATED ART

A technique of forming a protection film on a substrate using a paint composition has been conventionally used for various substrates such as plastic or wood materials, in order to protect a surface of the substrate or impart aesthetic or design properties.

As a paint composition, a curable composition including an oligomer having two or more (meth)acryloyl groups (hereinafter referred to as a “(meth)acrylic oligomer”) has been widely used. In addition, an active energy beam-curable composition that is cured when irradiated with an active energy beam has been widely used since the composition is advantageous in that, for example, it has rapid curing ability and enables steps to be reduced.

In addition, as an active energy beam-curable composition for paints, a compound referred to as an “urethane adduct” that is a reaction product of an organic polyisocyanate and a hydroxy group-containing (meth)acrylate is also used, as well as a (meth)acrylic oligomer. A composition including the urethane adduct is characterized in that a cured product thereof has excellent hardness and scratch resistance.

Conventionally known (meth)acrylic oligomers are urethane (meth)acrylates, epoxy(meth)acrylates, and polyester(meth)acrylates.

These (meth)acrylic oligomers have a high viscosity and a poor leveling property. Therefore, they may be diluted with organic solvents such that they have a lowered viscosity for coating, in order to improve the leveling property. While the composition has an improved leveling property when coating, an appearance of a cured film after drying of an organic solvent and irradiation with an active energy beam becomes poor. Urethane adducts also have similar problems.

In order to solve problems other than the above, there have been attempts to blend (meth)acrylate, which per se is cured when irradiated with an active energy beam and enables a composition to have lowered viscosity, that is to say, a reactive diluent.

Specifically, there are known mixtures obtained by blending an (meth)acrylic oligomer and, as a low-viscosity reactive diluent, a bifunctional or trifunctional (meth)acrylate monomer such as tetraethylene glycol diacrylate (hereinafter referred to as “TEGDA”), trimethylolpropane triacrylate (hereinafter referred to as “TMPTA”), or ethylene oxide-modified trimethylolpropane triacrylate (hereinafter referred to as “EO-TMPTA”), each having a viscosity of 100 mPa·s or less at 25° C. (Patent Documents 1, 2, and 3).

It is possible to improve a leveling property when coating and thereby improve a cured film appearance with the use of these compositions.

However, although a composition including the above-described known reactive diluent enables a cured film appearance to be improved, it has been problematic in that cured film physical properties which (meth)acrylic oligomers originally have, specifically, hardness, scratch resistance, and the like, are impaired. A composition including a urethane adduct also has similar problems.

### PRIOR ART REFERENCES

### Patent Documents

Patent Document 1: Japanese Patent Application Laid-Open (JP-A) No. H04-77514

Patent Document 2: JP-A No. H10-259218

Patent Document 3: JP-A No. 2005-75987

### SUMMARY OF INVENTION

### Technical Problem

The inventors of the invention made intensive studies to find out a curable composition that has low viscosity and is excellent in terms of appearance and hardness of a cured product, which is preferably an active energy beam-curable composition.

### Solution to Problem

In order to solve the above-described problems, it is considered effective to use, as a low-viscosity reactive diluent, glycerin tri(meth)acrylate (hereinafter referred to as “GLY-TA”) which is a compound having an acryloyl group in high concentration and not having ethylene oxide chains.

In order to industrially obtain GLY-TA, a method of producing GLY-TA by carrying out dehydration-esterification of glycerin and acrylic acid can be employed. However, reactivity of a secondary hydroxy group is especially low in dehydration-esterification reaction, which results in production of a high-molecular-weight body in a large amount. This makes it difficult to industrially obtain GLY-TA. That's why GLY-TA is not available in the market. Therefore, there exists no known conventional curable composition including an oligomer having a (meth)acryloyl group, a urethane adduct, or a combination thereof, and GLY-TA.

In order to solve the above-described problems, the inventors found that a specific curable composition including GLY-TA, and a (meth)acrylic oligomer, a urethane adduct, or a combination thereof has low viscosity and is excellent in terms of appearance and hardness of a cured product. This has led to the completion of the invention.

The invention is explained in detail below.

### Advantageous Effects of Invention

According to the composition of the invention, the composition has low viscosity and is excellent in terms of appearance and hardness of a cured product, and the composition satisfies both of these features.

### DESCRIPTION OF EMBODIMENTS

The invention relates to a curable composition including the following components (A) and (B).

component (A): a (meth)acrylate mixture including GLY-TA as a main component, the mixture including a high-molecular-weight body, for which an area percent (%) is defined by the following Equation (1) and is a value obtained in accordance with gel permeation chromatography measurement (hereinafter referred to as “GPC”), is less than 30%:

Area percent of high-molecular-weight body (%)=[(R−I−L)/R]×100 Equation (1):

in which symbols and terms in Equation (1) each are described below.

component (B): a methacryl oligomer, a reaction product of an organic polyisocyanate and a hydroxy group-containing (meth)acrylate (hereinafter referred to as an “urethane adduct”), or a combination thereof.

The components (A) and (B), other components, and a method of using these components are described below.

1. Component (A)

The component (A) is a (meth)acrylate mixture including GLY-TA as a main component.

In the invention, the component (A) is intended to include GLY-TA as a main component. Therefore, for a high-molecular-weight body in the component (A), the area percent (%) of the high-molecular-weight body defined by the following Equation (1), which is a value obtained in accordance with GPC measurement, is less than 30%, preferably less than 25%, and more preferably less than 20%.

Area percent of high-molecular-weight body (%)=[(R−I−L)/R]×100 Equation (1):

Symbols and terms used in Equation (1) each have the following meanings,
R: Total area of detection peaks in the component (A),
I: Area of detection peaks including GLY-TA,
L: Total area of detection peaks for a weight-average molecular weight (hereinafter referred to as “Mw”) smaller than that for detection peaks including GLY-TA.

Note that, Mw in the invention refers to a value obtained by converting a molecular weight measured by GPC using tetrahydrofuran (hereinafter referred to as “THF”) as a solvent with reference to a molecular weight of polystyrene.

By setting the area percent (%) of a high-molecular-weight body in the component (A) within the above range, it is possible to achieve low viscosity of a composition and obtain a composition of which cured product has excellent hardness.

The molecular weight measured by GPC in the invention means a value measured under the following conditions.
Detector: Differential refractometer (RI detector)
Column type: Crosslinked polystyrene-based column
Column temperature: From 25° C. to 50° C.
Eluent: THF

It is preferable that the component (A) includes GLY-TA as a main component and has a low hydroxy valence. Specifically, the hydroxy valence thereof is preferably 60 mg KOH/g or less and more preferably 45 mg KOH/g or less.

By setting the hydroxy valence of the component (A) within the above range, it is possible to achieve low viscosity of a composition and obtain a composition of which cured product has excellent hardness.

The term “hydroxy valence” used in the invention refers to a value of milligram (mg) of potassium hydroxide equivalent to an amount of a hydroxy group in 1 g of a sample.

The component (A) is preferably obtained by carrying out transesterification of glycerin and a compound having one (meth)acryloyl group (hereinafter referred to as a “monofunctional (meth)acrylate”).

As described above, in a production method including carrying out dehydration-esterification of glycerin and (meth)acrylic acid, a high-molecular-weight body is produced in a large amount since reactivity of a secondary hydroxy group is low, thereby making it difficult to industrially produce GLY-TA. On the other hand, it becomes possible to produce a (meth)acrylate mixture including GLY-TA as a main component by transesterification of glycerin and a monofunctional (meth)acrylate.

In the case of transesterification of glycerin and a monofunctional (meth)acrylate, a (meth)acrylate mixture can be obtained. Specifically, in addition to GLY-TA, glycerin di(meth)acrylate and a high-molecular-weight body are obtained, and a small amount of glycerin mono(meth)acrylate may be obtained depending on production conditions.

Examples of a high-molecular-weight body include a polyfunctional(meth)acrylate having a Michael addition-type structure such as a compound in which a hydroxy group of glycerin di(meth)acrylate is added to a (meth)acryloyl group of GLY-TA by Michael addition.

Regarding a method of producing the component (A) by transesterification, methods of producing a polyalcohol, a monofunctional (meth)acrylate, a catalyst, and a component (A) are described below.

1-1. Polyalcohol

A polyalcohol used as the component (A) material is glycerin.

In the invention, glycerin and one or more polyalcohols other than glycerin (hereinafter referred to as “other polyalcohols”) may be optionally used in combination as long as an effect of the invention is not impaired.

A proportion of other polyalcohols used in combination is preferably 50 parts by weight or less with respect to 100 parts by weight of glycerin.

Examples of other polyalcohols include an aliphatic alcohol, an alicyclic alcohol, an aromatic alcohol, a polyalcohol ether, each of which has at least two alcoholic hydroxy groups in its molecule. They may each have, in its molecule, other functional group or bond such as a phenolic hydroxy group, a ketone group, an acyl group, an aldehyde group, a thiol group, an amino group, an imino group, a cyano group, a nitro group, a vinyl group, an ether bond, an ester bond, a carbonate group, an amide bond, an imide bond, a peptide bond, a urethane bond, an acetal bond, a hemiacetal bond, or a hemiketal bond.

Specific examples of a divalent alcohol having two alcoholic hydroxy groups include ethylene glycol, diethylene glycol, triethylene glycol, polyethylene glycol, propylene glycol, trimethylene glycol, dipropylene glycol, tripropylene glycol, polypropylene glycol, butanediol, pentanediol, hexanediol, heptanediol, nonanediol, neopentyl glycol, cyclohexanediol, cyclohexanedimethanol, dioxane glycol, N-methyldiethanolamine, N-ethyldiethanolamine, N-butyldiethanolamine, N-tert-butyldiethanolamine, N-lauryldiethanolamine, stearyldiethanolamine, N-phenyldiethanolamine, m-tolyldiethanolamine, p-tolyldiethanolamine, N,N′-bis(2-hydroxypropyl)aniline, N-nitrosodiethanolamine, N-(2-hydroxyethyl)lactamide, N,N′-bis(2-hydroxyethyl)oxamide, 3-morpholino-1,2-propanediol, 2,6-pyridinedimethanol, 3-(dimethylamino)-1,2-propanediol, 3-(diethylamino)-1,2-propanediol, alloxanthine dihydrate, (+)-N,N,N′,N′-tetramethyl-L-tartardiamide, (−)-N,N,N′,N′-tetramethyl-D-tartardiamide, N-propyl-N-(2,3-dihydroxypropyl)perfluoro-n-octylsulfonamide, thymidine, chloramphenicol, thiamphenicol, D-erythronolactone, methyl 4,6-O-benzylidene-α-D-glucopyranoside, phenyl 4,6-O-benzylidene-1-thio-β-D-glucopyranoside, 1,2:5,6-di-O-isopropylidene-D-mannitol, 1,2-O-isopropylidene-α-D-xylofuranose, 2,6-di-O-palmitoyl-L-ascorbic acid, isosorbide, and an alkylene oxide adduct thereof, and further include an alkylene oxide adduct of a compound having a phenolic hydroxy group, such as hydroquinone, bisphenol A, bisphenol AP, bisphenol AF, bisphenol B, bisphenol BP, bisphenol C, bisphenol E, bisphenol F, bisphenol G, bisphenol M, bisphenol S, thiobisphenol, bisphenol P, bisphenol PH, bisphenol TMC, or bisphenol Z, and an alcohol having a carbonate bond, such as a polycarbonatediol.

Specific examples of a trivalent alcohol having three alcoholic hydroxy groups include trimethylolethane, trimethylolpropane, tris(2-hydroxyethyl)isocyanurate, hexanetriol, octanetriol, decanetriol, triethanolamine, triisopropanol amine, 1-[bis2-(hydroxyethyl)amino]-2-propanol, D-panthenol, DL-panthenol, uridine, 5-methyluridine, cytidine, inosine, adenosine, leucomycin A3, leucomycin A4, leucomycin A6, leucomycin A8, clindamycin hydrochloride monohydrate, prednisolone, methyl β-D-arabinopyranoside, methyl β-L-fucopyranoside, methyl α-L-fucopyranoside, D-galactal, 4-methoxyphenyl 3-O-allyl-β-D-galactopyranoside, 4-methoxyphenyl 3-O-benzyl-β-D-galactopyranoside, 1,6-anhydro-β-D-glucose, α-chloralose, β-chloralose, 4,6-O-ethylidene-α-D-glucopyranose, D-glucal, 1,2-O-isopropylidene-α-D-glucofuranose, D-glucurono-6,3-lactone, 2-deoxy-D-ribose, methyl β-D-ribofuranoside, D-(+)-ribono-1,4-lactone, methyl-β-D-xylopyranoside, 6-O-palmitoyl-L-ascorbic acid, 6-O-stearoyl-L-ascorbic acid, 3-O-ethyl-L-ascorbic acid, and an alkylene oxide adduct thereof

Specific examples of a quadrivalent alcohol having four alcoholic hydroxy groups include ditrimethylolethane, ditrimethylolpropane, diglycerin, pentaerythritol, N,N,N′,N′-tetrakis(2-hydroxyethyl)butanediamide, N,N,N′,N′-tetrakis(2-hydroxypropyl)butanediamide, N,N,N′,N′-tetrakis(2-hydroxyethyl)hexanediamide, N,N,N′,N′-tetrakis(2-hydroxypropyl)hexanediamide, N,N,N′,N′-tetrakis(2-hydroxyethyl)ethylene diamine, N,N,N′,N′-tetrakis(2-hydroxypropyl)ethylene diamine, N-hexanoyl-D-glucosamine, N-valeryl-D-glucosamine, N-trifluoroacetyl-D-glucosamine, N-benzoyl-D-glucosamine, 5-acetamide-N,N′-bis(2,3-dihydroxypropyl)-2,4,6-triiodoisophthalamide, spiramycin, clarithromycin, leucomycin A1, leucomycin A5, leucomycin A7, leucomycin A9, leucomycin A13, lincomycin hydrochloride monohydrate, diazolidinyl urea, D-(−)-arabinose, DL-arabinose, L-(+)-arabinose, meso-erythritol, D-(+)-fucose, L-(−)-fucose, allyl α-D-galactopyranoside, methyl β-D-galactopyranoside, methyl α-D-galactopyranoside monohydrate, 4-methoxyphenyl β-D-galactopyranoside, 2-nitrophenyl β-D-galactopyranoside, 4-nitrophenyl α-D-galactopyranoside, 4-nitrophenyl β-D-galactopyranoside, phenyl β-D-galactopyranoside, N-acetyl-D-galactosamine hydrate, D-(+)-galactosamine hydrochloride, arbutin, 2-deoxy-D-glucose, esculin 1.5-hydrate, D-(+)-glucono-1,5-lactone, D-glucuronamide, helicin, methyl α-D-glucopyranoside, methyl β-D-glucopyranoside 0.5-hydrate, 4-methoxyphenyl β-D-glucopyranoside, 4-nitrophenyl β-D-glucopyranoside monohydrate, 4-nitrophenyl α-D-glucopyranoside, nonyl β-D-glucopyranoside, n-octyl β-D-glucopyranoside, phenyl β-D-glucopyranoside hydrate, phlorhizin hydrate, piceid, puerarin, N-acetyl-D-glucosamine, N-benzoyl-D-glucosamine, D-(+)-glucosaminehydrochloride, N-hexanoyl-D-glucosamine, N-valeryl-D-glucosamine, L-(+)-gulonic acid γ-lactone, D-(−)-lyxose, L-(+)-lyxose, 3,4-O-isopropylidene-D-mannitol, methyl α-D-mannopyranoside, D-mannono-1,4-lactone, 4-methoxyphenyl α-D-mannopyranoside, N-acetyl-D-mannosamine monohydrate, D-(−)-ribose, L-ribose, D-(+)-xylose, DL-xylose, L-(−)-xylose, D-araboascorbic acid, L-ascorbic acid, L-threitol, and an alkylene oxide adduct thereof.

Specific examples of a pentavalent alcohol having five alcoholic hydroxy groups include tritrimethylolethane, tritrimethylolpropane, triglycerin, bis(2-hydroxyethyl)aminotris(hydroxymethyl)methane, bis(2-hydroxypropyl)aminotris(hydroxymethyl)methane, N,N,N′,N″,N″-pentakis(2-hydroxyethyl)diethylenetriamine, N,N,N′,N″,N″-pentakis(2-hydroxypropyl)diethylenetriamine, miglitol, erythoromycin, azithromycin dihydrate, D-(+)-arabitol, DL-arabitol, L-(−)-arabitol, D-(−)-fructose, L-(+)-fructose, D-(+)-galactose, L-(−)-galactose, β-D-glucose, D-(+)-glucose, L-(−)-glucose, D-glucosediethyl mercaptal, salicin, L-gulose, D-(+)-mannose, L-(−)-mannose, ribitol, L-(−)-sorbose, D-tagatose, xylitol, sucralose, glyceryl ascorbate, and an alkylene oxide adduct thereof

Specific examples of a polyalcohol having six or more alcoholic hydroxy groups include polytrimethylolethane, polytrimethylolpropane, polyglycerin, dipentaerythritol, tripentaerythritol, polypentaerythritol, iohexol, galactitol, D-sorbitol, L-sorbitol, myo-inositol, scyllo-inositol, D-mannitol, L-mannitol, icariin, amygdalin, D-(+)-cellobiose, diosmin, 2-O-α-D-glucopyranosyl-L-ascorbic acid, hesperidin, D-(+)-lactose monohydrate, lactulose, D-(+)-maltose monohydrate, D-(+)-melibiose monohydrate, methylhesperidin, maltitol, naringin hydrate, neohesperidin dihydrochalcone hydrate, palatinose hydrate, rutin hydrate, D-(+)-sucrose, stevioside, D-(+)-turanose, D-(+)-trehalose (anhydrous), D-(+)-trehalose dihydrate, D-(+)-melezitose hydrate, D-(+)-raffinose pentahydrate, rebaudioside A, stachyose, α-cyclodextrin,β-cyclodextrin, γ-cyclodextrin, starch, polyvinyl alcohol, and an alkylene oxide adduct thereof.

1-2. Monofunctional (Meth)Acrylate

A monofunctional (meth)acrylate used as a starting material for the component (A) is a compound having one (meth)acryloyl group in its molecule, examples of which is a compound represented by the following Formula (1).

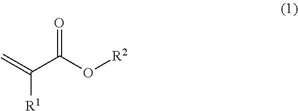

In Formula (1), R¹ represents a hydrogen atom or a methyl group. R² represents a C₁₋₅₀ organic group.

Specific examples of R² in the above-described Formula (1) include a methyl group, an ethyl group, a n- or i-propyl group, a n-, i- or t-butyl group, a n-, s- or t-amyl group, a neopentyl group, a n-, s-, or t-hexyl group, a n-, s-, or t-heptyl group, a n-, s-, or t-octyl group, a 2-ethylhexyl group, a capryl group, a nonyl group, a decyl group, an undecyl group, a lauryl group, a tridecyl group, a myristyl group, a pentadecyl group, a cetyl group, a heptadecyl group, a stearyl group, a nonadecyl group, an arachidyl group, a seryl group, a myricyl group, a mericyl group, a vinyl group, an allyl group, a methallyl group, a crotyl group, a 1,1-dimethyl-2-propenyl group, a 2-methylbutenyl group, a 3-methyl-2-butenyl group, a 3-methyl-3-butenyl group, a 2-methyl-3-butenyl group, a butenyl group, a pentenyl group, a hexenyl group, a heptenyl group, an octenyl group, a nonenyl group, a decenyl group, an undecenyl group, a dodecenyl group, a tridecenyl group, a tetradecenyl group, a pentadecenyl group, a hexadecenyl group, a heptadecenyl group, an oleyl group, a linol group, a linolen group, a cyclopentyl group, a cyclopentylmethyl group, a cyclohexyl group, a cyclohexylmethyl group, a 4-methylcyclohexyl group, a 4-t-butylcyclohexyl group, a tricyclodecanyl group, an isobornyl group, an adamantyl group, a dicyclopentanyl group, a dicyclopentenyl group, a phenyl group, a methylphenyl group, a dimethylphenyl group, a trimethylphenyl group, a 4-t-butylphenyl group, a benzyl group, a diphenylmethyl group, a diphenylethyl group, a triphenylmethyl group, a cinnamyl group, a naphthyl group, an anthranil group, a methoxyethyl group, a methoxyethoxyethyl group, a methoxyethoxyethoxyethyl group, a 3-methoxybutyl group, an ethoxyethyl group, an ethoxyethoxyethyl group, a cyclopentoxyethyl group, a cyclohexyloxyethyl group, a cyclopentoxyethoxyethyl group, a cyclohexyloxyethoxyethyl group, a dicyclopentenyl oxyethyl group, a phenoxyethyl group, a phenoxyethoxyethyl group, a glycidyl group, a β-methylglycidyl group, a β-ethylglycidyl group, a 3,4-epoxy cyclohexylmethyl group, a 2-oxetanemethyl group, a 3-methyl-3-oxetanemethyl group, a 3-ethyl-3-oxetanemethyl group, a tetrahydrofuranyl group, a tetrahydrofurfuryl group, a tetrahydropyranyl group, a dioxazolinyl group, a dioxanyl group, an N,N-dimethylaminoethyl group, an N,N-diethylaminoethyl group, an N,N-dimethylaminopropyl group, an N,N-diethylaminopropyl group, an N-benzyl-N-methylaminoethyl group, and an N-benzyl-N-methylaminopropyl group.

Among these functional groups, R² is preferably a C₁₋₈ alkyl group such as a methyl group, an ethyl group, a propyl group, a butyl group, a pentyl group, a hexyl group, a heptyl group, an octyl group, or a 2-ethylhexyl group, an alkoxyalkyl group such as a 2-methoxyethyl group, a 2-ethoxyethyl group, or a 2-methoxybutyl group, or a dialkyl amino group such as an N,N-dimethylaminoethyl group, an N,N-diethylaminoethyl group, an N,N-dimethylaminopropyl group, or N,N-diethylaminopropyl group.

The monofunctional (meth)acrylate may be used singly, or in any combination of two or more kinds thereof in the invention.

Among these monofunctional (meth)acrylates, an alkyl(meth)acrylate having a C₁₋₈ alkyl group such as methyl(meth)acrylate, ethyl(meth)acrylate, n-butyl(meth)acrylate, i-butyl(meth)acrylate, or 2-ethylhexyl(meth)acrylate, an alkoxyalkyl(meth)acrylate such as 2-methoxyethylacrylate, and N,N-dimethylaminoethyl(meth)acrylate are preferable, and a (meth)acrylate having a C₁₋₄ alkyl group and an alkoxyalkyl(meth)acrylate having a C₁₋₂ alkyl group, which exhibit favorable reactivity with most of polyalcohols and are readily available, are particularly preferable.

Further, an alkoxyalkyl(meth)acrylate having a C₁₋₂ alkyl group, which promotes dissolution of polyalcohols and exhibit extremely favorable reactivity, is more preferable, and 2-methoxyethyl(meth)acrylate is particularly preferable.

Furthermore, since an acrylate has excellent reactivity, the acrylate is particularly preferable as the monofunctional (meth)acrylate.

Proportions of the polyalcohol and the monofunctional (meth)acrylate used in the method of producing the component (A) are not particularly limited. An amount of the monofunctional (meth)acrylate is preferably from 0.4 to 10.0 mol and more preferably from 0.6 to 5.0 mol, with respect to 1 mol in total of hydroxy groups in the polyalcohol. It is possible to prevent a side reaction by setting the amount of the monofunctional (meth)acrylate to 0.4 mol or more. It is possible to increase a production amount of GLY-TA by setting the amount of the monofunctional (meth)acrylate to 10.0 mol or less, thereby improving productivity.

1-3. Catalyst

As transesterification catalysts in the method of producing the component (A), conventionally known catalysts such as tin-based catalysts, titanium-based catalysts, or sulfuric acid can be used.

In the invention, it is preferable to use the following catalysts X and Y since GLY-TA can be efficiently produced at a high yield.

catalyst X: at least one compound selected from the group consisting of a cyclic tertiary amine having an azabicyclo structure or a salt or complex thereof (hereinafter referred to as an “azabicyclo-based compound”), an amidine or a salt or complex thereof (hereinafter referred to as an “amidine-based compound”), a compound having a pyridine ring or a salt or complex thereof (hereinafter referred to as a “pyridine-based compound”), and a phosphine or a salt or complex thereof (hereinafter referred to as “phosphine-based compound”) catalyst Y: a compound including zinc

The catalysts X and Y are explained below.

1-3-1. Catalyst X

The catalyst X is at least one member selected from the group consisting of an azabicyclo-based compound, an amidine-based compound, a pyridine-based compound, and a phosphine-based compound.

Among the above-described compounds, the catalyst X is preferably at least one compound selected from the group consisting of an azabicyclo-based compound, an amidine-based compound, and a pyridine-based compound. These compounds have excellent catalyst activity so that the component (A) can be preferably produced. In addition, these compounds each form a complex with a catalyst Y described below after the termination of reaction, and the complex can be readily removed from a reaction solution after the termination of reaction by a convenient method such as filtration or adsorption, since the complex is slightly soluble in the reaction solution. In particular, since a complex of an azabicyclo-based compound with the catalyst Y is slightly soluble in a reaction solution, the complex can be removed more readily by filtration, adsorption, or the like.

Meanwhile, although a phosphine-based compound has excellent catalyst activity, the compound is unlikely to form a complex with the catalyst Y. If a complex is formed, the complex is readily soluble in a reaction solution and the most of the phosphine-based compound or the complex remains dissolved in the reaction solution after the termination of reaction, which makes it difficult to carry out removal from the reaction solution by a convenient method such as filtration or adsorption. Therefore, the phosphine-based catalyst remains even in a final product, which results in problems of preservation stability that turbidness or precipitation of a catalyst appears during storage of a product, or thickening or gelating occurs with the lapse of time. There are similar problems also in a case of being used as a component of a composition.

Specific examples of the azabicyclo-based compound include 1-azabicyclo[1,1,0]butane, 1,3-diazabicyclo[1,1,0]butane, 1-azabicyclo[2,1,0]heptane, 1,3-diazabicyclo[2,1,0]heptane, 1,4-diazabicyclo[2,1,0]heptane, 1-azabicyclo[2,2,0]hexane, 1,3-diazabicyclo[2,2,0]hexane, 1-azabicyclo[2,1,1]hexane, 1,3-diazabicyclo[2,1,1]hexane, 1-azabicyclo[2,2,1]heptane, 1,3-diazabicyclo[2,2,1]heptane, 1,4-diazabicyclo[2,2,1]heptane, 1-azabicyclo[3,2,0]heptane, 1,3-diazabicyclo[3,2,0]heptane, 1,4-diazabicyclo[3,2,0]heptane, 1,6-diazabicyclo[3,2,0]heptane, 1,3-diazabicyclo[2,2,2]octane, 1-azabicyclo[3,2,1]octane, 1,3-diazabicyclo[3,2,1]octane, 1,4-diazabicyclo[3,2,1]octane, 1,5-diazabicyclo[3,2,1]octane, 1,6-diazabicyclo[3,2,1]octane, 1-azabicyclo[4,1,1]octane, 1,3-diazabicyclo[4,1,1]octane, 1,4-diazabicyclo[4,1,1]octane, 1,5-diazabicyclo[4,1,1]octane, 1,6-diazabicyclo[4,1,1]octane, 1,7-diazabicyclo[4,1,1]octane, 1-azabicyclo[4,2,0]octane, 1,3-diazabicyclo[4,2,0]octane, 1,4-diazabicyclo[4,2,0]octane, 1,5-diazabicyclo[4,2,0]octane, 1,7-diazabicyclo[4,2,0]octane, 1-azabicyclo[3,3,1]nonane, 1,3-diazabicyclo[3,3,1]nonane, 1,4-diazabicyclo[3,3,1]nonane, 1,5-diazabicyclo[3,3,1]nonane, 1-azabicyclo[3,2,2]nonane, 1,3-diazabicyclo[3,2,2]nonane, 1,4-diazabicyclo[3,2,2]nonane, 1,5-diazabicyclo[3,2,2]nonane, 1,6-diazabicyclo[3,2,2]nonane, 1,8-diazabicyclo[3,2,2]nonane, 1-azabicyclo[4,3,0]nonane, 1,3-diazabicyclo[4,3,0]nonane, 1,4-diazabicyclo[4,3,0]nonane, 1,5-diazabicyclo[4,3,0]nonane, 1,6-diazabicyclo[4,3,0]nonane, 1,7-diazabicyclo[4,3,0]nonane, 1,8-diazabicyclo[4,3,0]nonane, 1-azabicyclo[4,2,1]nonane, 1,3-diazabicyclo[4,2,1]nonane, 1,4-diazabicyclo[4,2,1]nonane, 1,5-diazabicyclo[4,2,1]nonane, 1,6-diazabicyclo[4,2,1]nonane, 1,7-diazabicyclo[4,2,1]nonane, 1-azabicyclo[5,2,0]nonane, 1,3-diazabicyclo[5,2,0]nonane, 1,3-diazabicyclo[5,2,0]nonane, 1,4-diazabicyclo[5,2,0]nonane, 1,5-diazabicyclo[5,2,0]nonane, 1,6-diazabicyclo[5,2,0]nonane, 1,7-diazabicyclo[5,2,0]nonane, 1,8-diazabicyclo[5,2,0]nonane, 1-azabicyclo[5,1,1]nonane, 1,3-azabicyclo[5,1,1]nonane, 1,4-azabicyclo[5,1,1]nonane, 1,5-azabicyclo[5,1,1]nonane, 1,6-azabicyclo[5,1,1]nonane, 1,7-azabicyclo[5,1,1]nonane, 1-azabicyclo[6,1,0]nonane, 1,3-diazabicyclo[6,1,0]nonane, 1,4-diazabicyclo[6,1,0]nonane, 1,5-diazabicyclo[6,1,0]nonane, 1,6-diazabicyclo[6,1,0]nonane, 1,7-diazabicyclo[6,1,0]nonane, 1,8-diazabicyclo[6,1,0]nonane, 1-azabicyclo[7,1,0]decane, 1,9-diazabicyclo[7,1,0]decane, 1-azabicyclo[6,2,0]decane, 1,8-diazabicyclo[6,2,0]decane, 1-azabicyclo[6,1,1]decane, 1,8-diazabicyclo[6,1,1]decane, 1-azabicyclo[5,3,0]decane, 1,7-diazabicyclo[5,3,0]decane, 1-azabicyclo[5,2,1]decane, 1,7-diazabicyclo[5,2,1]decane, 1-azabicyclo[4,3,1]decane, 1,6-diazabicyclo[4,3,1]decane, 1-azabicyclo[4,2,2]decane, 1,6-diazabicyclo[4,2,2]decane, 1-azabicyclo[5,4,0]undecane, 1,7-diazabicyclo[5,4,0]undecane, 1-azabicyclo[5.3.1]undecane, 1,7-diazabicyclo[5,3,1]undecane, 1-azabicyclo[5,2,2]undecane, 1,7-diazabicyclo[5,2,2]undecane, 1-azabicyclo[4,4,1]undecane, 1,7-diazabicyclo[4,4,1]undecane, 1-azabicyclo[4,3,2]undecane, 1,7-diazabicyclo[4,3,2]undecane, 1-azabicyclo[3,3,0]octane, 1-azabicyclo[4,3,0]nonane, quinuclidine, lupinane, lupinine, quinolizidine, 3-hydroxyquinuclidine, 3-quinuclidinone, quincorine, quincoridine, cinchonidine, cinchonine, quinidine, kinin, cupreine, ibogaine, swainsonine, castanospermine, mianserin, mirtazapine, canadine, Tröger's base, 1-azabicyclo[2,2,2]octane-3-carboxylic acid, triethylene diamine (also known as 1,4-diazabicyclo[2,2,2]octane, hereinafter referred to as “DABCO”), hexamethylenetetramine, 3-quinolidinone hydrochloride, 3-chloro-1-azabicyclo[2,2,2]octane hydrochloride, cinchonidine dihydrochloride, cinchonine hydrochloride hydrate, cinchonidine sulfate dihydrate, hydroquinidine hydrochloride, cinchonine sulfate dihydrate, quinine hydrochloride dihydrate, quinine sulfate dihydrate, quinine phosphate, quinidine sulfate dihydrate, mianserin hydrochloride, 1,1′-(butane-1,4-diyl)bis[4-aza-1-azoniabicyclo[2,2,2]octane]dibromide, 1,1′-(decane-1,10-diyl)bis[4-aza-1-azoniabicyclo[2,2,2]octane]dibromide, bis(trimethylaluminum)-1,4-diazabicyclo[2,2,2]octane adduct, bismuthine, quinuclidine hydrochloride, 3-quinuclidinone hydrochloride, 3-hydroxyquinuclidine hydrochloride, DABCO hydrochloride, quinuclidine acetate, 3-quinuclidinone acetate, 3-hydroxyquinuclidine acetate, DABCO acetate, quinuclidine acrylate, 3-quinuclidinone acrylate, 3-hydroxyquinuclidine acrylate, and DABCO acrylate.

Specific examples of the amidine-based compound include imidazole, N-methylimidazole, N-ethylimidazole, 1-benzyl-2-methylimidazole, 1-benzyl-2-phenylimidazole, 1-vinyl imidazole, 1-allylimidazole, 1,8-diazabicyclo[5,4,0]undeca-7-ene (hereinafter referred to as “DBU”), 1,5-diazabicyclo[4,3,0]nona-5-ene (hereinafter referred to as “DBN”), N-methylimidazole hydrochloride, DBU hydrochloride, DBN hydrochloride, N-methylimidazole acetate, DBU acetate, DBN acetate, N-methylimidazole acrylate, DBU acrylate, DBN acrylate, and phthalimide DBU.

Specific examples of the pyridine-based compound include pyridine, 2-methylpyridine, 3-methylpyridine, 4-methylpyridine, 2-ethylpyridine, 3-ethylpyridine, 4-ethylpyridine, 2-propylpyridine, 4-propylpyridine, 4-isopropylpyridine, 4-tert-butylpyridine, 4-amyl pyridine, 4-(1-ethylpropyl)pyridine, 4-(5-nonyl)pyridine, 2-vinylpyridine, 2,3-dimethylpyridine, 2,4-dimethylpyridine, 2,5-dimethylpyridine, 2,6-dimethylpyridine, 3,4-dimethylpyridine, 3,5-dimethylpyridine, 3,5-diethylpyridine, N,N-dimethyl-4-aminopyridine (hereinafter referred to as “DMAP”), 2,4,6-trimethylpyridine, 2,6-di-tert-butylpyridine, N,N-dimethyl-2-aminopyridine, 4-piperidinopyridine, 4-pyrrolidinopyridine, 4-phenylpyridine, quinoline, 2-methylquinoline, 3-methylquinoline, 4-methylquinoline, 6-methylquinoline, 7-methylquinoline, 8-methylquinoline, isoquinoline, 1-methylisoquinoline, acridine, 3,4-benzoquinoline, 5,6-benzoquinoline, 7,8-benzoquinoline, 2-hydroxypyridine, 3-hydroxypyridine, 4-hydroxypyridine, 2,6-dihydroxypyridine, 2-(hydroxymethyl)pyridine, 3-(hydroxymethyl)pyridine, 4-(hydroxymethyl)pyridine, 5-hydroxyisoquinoline, 2-methoxypyridine, 3-methoxypyridine, 4-methoxypyridine, 2,6-dimethoxypyridine, 1,5-naphthyridine, 1,6-naphthyridine, 1,7-naphthyridine, 1,8-naphthyridine, 2,6-naphthyridine, 2,7-naphthyridine, 2,2′-bipyridyl, 3,3′-bipyridyl, 4,4′-bipyridyl, 2,3′-bipyridyl, 2,4′-bipyridyl, 3,4′-bipyridyl, 4,4′-ethylenedipyridine, 1,3-di(4-pyridyl)propane, 1,10-phenanthroline monohydrate, 2-(trimethylsilyl)pyridine, DMAP hydrochloride, DMAP acetate, DMAP acrylate, 1-methylpyridinium chloride, 1-propylpyridinium chloride, a borane-pyridine complex, a borane-2-picoline complex, and p-toluenesulfonic acid pyridinium.

Examples of the phosphine-based compound include a compound having a structure represented by the following Formula (2).

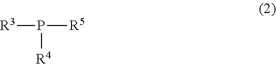

In Formula (2), R³, R⁴, and R⁵ each represent a C₁₋₂₀ linear or branched alkyl group, a C₁₋₂₀ linear or branched alkenyl group, a C₆₋₂₄ aryl group, or a C₅₋₂₀ cycloalkyl group. R³, R⁴, and R⁵ may be the same or different.

Specific examples of the phosphine-based compound include triphenylphosphine, (S)-(−)-BINAP, (R)-(+)-BINAP, (±)-BINAP, 2,2′-bis(diphenylphosphino)biphenyl, xantphos, 4,6-bis(diphenylphosphino)phenoxazine, bis[2-(diphenylphosphino)phenyl]ether, (2-bromophenyl)diphenylphosphine, bis(pentafluorophenyl)phenylphosphine, sodium diphenylphosphinobenzene-3-sulfonate, diphenyl-1-pyrenylphosphine, diphenyl-2-pyridylphosphine, 4-(dimethylamino)phenyldiphenylphosphine, 1,1′-bis(diphenylphosphino)ferrocene, (R,R″)-2,2″-bis(diphenylphosphino)-1,1″-biferrocene, (R)-N,N-dimethyl-1-[(S)-2-(diphenylphosphino)ferrocenyl]ethylamine, (S)-N,N-dimethyl-1-[(R)-2-(diphenylphosphino)ferrocenyl]ethylamine, (R)-N,N-dimethyl-1-[(S)-1′,2-bis(diphenylphosphino)ferrocenyl]ethylamine, (S)-N,N-dimethyl-1-[(R)-1′,2-bis(diphenylphosphino)ferrocenyl]ethylamine, a 4-diphenylphosphinomethylpolystyrene resin, (R)-(+)-2-diphenylphosphino-2′-methoxy-1,1′-binaphthyl, (S)-(−)-2-diphenylphosphino-2′-methoxy-1,1′-binaphthyl, 2-(diphenylphosphino)benzoate, 4-(diphenylphosphino)benzoate, 2-(diphenylphosphino)benzaldehyde, (S)-(−)-5,5′-bis[di(3,5-xylyl)phosphino]-4,4′-bi-1,3-benzodioxole, (R)-(+)-5,5′-bis[di(3,5-xylyl)phosphino]-4,4′-bi-1,3-benzodioxole, (S)-(+)-5,5′-bis[di(3,5-di-tert-butyl-4-methoxyphenyl)phosphino]-4,4′-bi-1,3-benzodioxole, (R)-(−)-5,5′-bis[di(3,5-di-tert-butyl-4-methoxyphenyl)phosphino]-4,4′-bi-1,3-benzodioxole, (pentafluorophenyl)diphenylphosphine, (S)-(−)-5,5′-bis(diphenylphosphino)-4,4′-bi-1,3-benzodioxole, (R)-(+)-5,5′-bis(diphenylphosphino)-4,4′-bi-1,3-benzodioxole, tris(4-methoxyphenyl)phosphine, tri(p-tolyl)phosphine, tri(o-tolyl)phosphine, tri(m-tolyl)phosphine, tris(2,6-dimethoxyphenyl)phosphine, a triphenylborane-triphenylphosphine complex, triphenylphosphine borane, tris(pentafluorophenyl)phosphine, tris[3,5-bis(trifluoromethyl)phenyl]phosphine, tris(4-fluorophenyl)phosphine, parastyryldiphenyl phosphine, tetraphenyl phosphonium bromide, methyltriphenyl phosphonium bromide, n-butyltriphenyl phosphonium bromide, methoxymethyltriphenyl phosphonium chloride, benzyltriphenylphosphonium chloride, tetraphenylphosphonium tetraphenylborate, tetraphenylphosphonium tetra-p-tolylborate, an ethyltriphenyl phosphonium acetate/acetic acid complex, ethyltriphenylphosphonium iodide, tris(4-methoxy-3,5-dimethylphenyl)phosphine, (+)-DIOP, (−)-DIOP, 1,2-bis(diphenylphosphino)ethane, 1,3-bis(diphenylphosphino)propane, 1,2-bis(dimethylphosphino)ethane, 1,4-bis(diphenylphosphino)butane, 1,6-bis(diphenylphosphino)hexane, 1,5-bis(diphenylphosphino)pentane, bis(diphenylphosphino)methane, trans-1,2-bis(diphenylphosphino)ethylene, (S,S)-chiraphos, (R,R)-DIPAMP, (S,S)-DIPAMP, 1,2-bis[bis(pentafluorophenyl)phosphino]ethane, (2R,3R)-(−)-Norphos, (2S,3S)-(+)-Norphos, 2-butenyl(di-tert-butyl)phosphine, cyclohexyldiphenylphosphine, dicyclohexyl(1,1-diphenyl-1-propene-2-yl)phosphine, diethylphenylphosphine, dicyclohexylphenylphosphine, diphenylpropylphosphine, 2-(di-tert-butylphosphino)biphenyl, 2-(dicyclohexylphosphino)biphenyl, 2-(dicyclohexylphosphino)-2′-(dimethylamino)biphenyl, 1-[2-(di-tert-butylphosphino)phenyl]-3,5-diphenyl-1H-pyrazole, di-tert-butylphenylphosphine, (4-dimethylaminophenyl)di-tert-butylphosphine, di-tert-butyl(3-methyl-2-butenyl)phosphine, ethyldiphenylphosphine, isopropyldiphenylphosphine, methyldiphenylphosphine, tricyclohexylphosphine, tri(2-furyl)phosphine, tri(2-thienyl)phosphine, tri-tert-butylphosphine, and tricyclopentylphosphine.

The catalyst X may be used singly, or in any combination of two or more kinds thereof in the invention. Among these catalysts X, quinuclidine, 3-quinuclidinone, 3-hydroxyquinuclidine, DABCO, N-methylimidazole, DBU, DBN, DMAP, triphenylphosphine, tri(p-tolyl)phosphine, tri(m-tolyl)phosphine, tris(4-methoxyphenyl)phosphine, and tris(4-methoxy-3,5-dimethylphenyl)phosphine are preferable. 3-hydroxyquinuclidine, DABCO, N-methylimidazole, DBU, DMAP, triphenylphosphine, and tri(m-tolyl)phosphine, which exhibit favorable reactivity with most of polyalcohols and are readily available, are particularly preferable.

A proportion of the catalyst X used in the method of producing the component (A) is not particularly limited. An amount of the catalyst X used is preferably from 0.0001 to 0.5 mol and more preferably from 0.0005 to 0.2 mol, with respect to 1 mol in total of hydroxy groups in a polyalcohol. It is possible to increase a production amount of GLY-TA of interest by using the catalyst X in an amount of 0.0001 mol or more. It is possible to prevent production of by-products or coloring of a reaction solution by setting the amount to 0.5 mol or less, thereby simplifying a purification step after the termination of reaction.

1-3-2. Catalyst Y

The catalyst Y is a compound including zinc.

As the catalyst Y, various compounds can be used as long as they include zinc. An organic acid zinc and a zinc diketone enolate are preferable since they have excellent reactivity.

Examples of the organic acid zinc include dibasic acid zinc such as zinc oxalate and a compound represented by the following Formula (3).

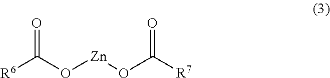

In Formula (3), R⁶ and R⁷ each represent a C₁₋₂₀ linear or branched alkyl group, a C₁₋₂₀ linear or branched alkenyl group, a C₆₋₂₄ aryl group, or a C₅₋₂₀ cycloalkyl group. R⁶ and R⁷ may be the same or different.

As a compound represented by Formula (3), a compound in which R⁶ and R⁷ each represent a C₁₋₂₀ linear or branched alkyl group is preferable. The C₁₋₂₀ linear or branched alkyl group as R⁶ and R⁷ is a functional group not having a halogen atom such as fluorine or chlorine, and the catalyst Y having the functional group is preferable since GLY-TA can be produced at a high yield.

Examples of the zinc diketone enolate include a compound represented by the following Formula (4).

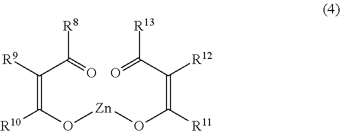

In Formula (4), R⁸, R⁹, R¹⁰, R¹¹, R¹², and R¹³ each represent a C₁₋₂₀ linear or branched alkyl group, a C₁₋₂₀ linear or branched alkenyl group, a C₆₋₂₄ aryl group, or a C₅₋₂₀ cycloalkyl group. R⁸, R⁹, R¹⁰, R¹¹, R¹², and R¹³ may be the same or different.

Specific examples of the compound including zinc represented by Formula (3) described above include zinc acetate, zinc acetate dihydrate, zinc propionate, zinc octylate, zinc neodecanoate, zinc laurate, zinc myristate, zinc stearate, zinc cyclohexane butyrate, zinc 2-ethylhexanoate, zinc benzoate, zinc t-butyl benzoate, zinc salicylate, zinc naphthenate, zinc acrylate, and zinc methacrylate.

In a case in which any these compounds including zinc forms a complex with a hydrate or solvate thereof or the catalyst X, the complex with the hydrate or solvate thereof or the catalyst X may be used as the catalyst Y in the method of producing the component (A).

Specific examples of the compound including zinc represented by Formula (4) described above include zinc acetylacetonate, zinc acetylacetonate hydrate, zinc bis(2,6-dimethyl-3,5-heptanedionate), zinc bis(2,2,6,6-tetramethyl-3,5-heptanedionate), and zinc bis(5,5-dimethyl-2,4-hexanedionate). In a case in which any of these compounds including zinc forms a complex with a hydrate or solvate thereof or the catalyst X, the complex with the hydrate or solvate thereof or the catalyst X may be used as the catalyst Y in the method of producing the component (A).

As the organic acid zinc and the zinc diketone enolate in the catalyst Y, the compound described above can be directly used or the compounds may be produced in a reaction system so as to be used.

For example, a zinc compound (hereinafter referred to as a “material zinc compound”) such as metal zinc, zinc oxide, zinc hydroxide, zinc chloride, or zinc nitrate is used as a starting material. In the case of an organic acid zinc, for example, a method of reacting the material zinc compound and an organic acid is employed. In the case of a zinc diketone enolate, for example, a method of reacting the material zinc compound and a 1,3-diketone is employed.

The catalyst Y may be used singly, or in any combination of two or more kinds thereof in the invention. Among these catalysts Y, zinc acetate, zinc propionate, zinc acrylate, zinc methacrylate, and zinc acetylacetonate are preferable. Zinc acetate, zinc acrylate, and zinc acetylacetonate, which exhibit favorable reactivity with most of polyalcohols and are readily available, are particularly preferable.

A proportion of the catalyst Y used in the method of producing the component (A) is not particularly limited. An amount of the catalyst Y is preferably from 0.0001 to 0.5 mol and more preferably from 0.0005 to 0.2 mol, with respect to 1 mol in total of hydroxy groups in a polyalcohol. It is possible to increase a production amount of GLY-TA of interest by using the catalyst Y in an amount of 0.0001 mol or more. It is possible to prevent production of by-products or coloring of a reaction solution by setting the amount to 0.5 mol or less, thereby simplifying a purification step after the termination of reaction.

1-4. Method of Producing Component (A) The component (A) is produced by carrying out transesterification of glycerin and a monofunctional (meth)acrylate under the presence of an esterification catalyst.

As described above, the method of producing the component (A) is preferably a production method using the catalysts X and Y in combination. The production method is described below.

Proportions of the catalysts X and Y used in the method of producing the component (A) are not particularly limited. An amount of the catalyst X used is preferably from 0.005 to 10.0 mol and more preferably from 0.05 to 5.0 mol, with respect to 1 mol of the catalyst Y. It is possible to increase a production amount of GLY-TA of interest by using the catalyst X in an amount of 0.005 mol or more. It is possible to prevent production of by-products or coloring of a reaction solution by setting the amount to 10.0 mol or less, thereby simplifying a purification step after the termination of reaction.

A preferable combination of the catalysts X and Y used in the invention is a combination of an azabicyclo-based compound as the catalyst X and a compound represented by Formula (3) described above as the catalyst Y. Further, a combination of DABCO as the azabicyclo-based compound and zinc acetate, zinc acrylate, or a combination thereof as the compound represented by Formula (3) described above is most preferable.

This combination is favorably employed for various industrial purposes with priority on color tone since GLY-TA can be obtained at a high yield, and excellent color tone can be achieved after the termination of reaction. Further, since the catalysts are available at relatively inexpensive prices, the production method is economically advantageous.

The catalysts X and Y used in the invention may be added at the beginning of or in the middle of the reaction described above. The desired amounts of the catalysts used may be added at once or in divided portions.

A reaction temperature in the method of producing the component (A) is preferably from 40° C. to 180° C. and more preferably from 60° C. to 160° C. It is possible to increase a reaction rate by setting the reaction temperature to 40° C. or higher. It is possible to prevent thermal polymerization of (meth)acryloyl groups in the starting material or product, or coloring of a reaction solution by setting the reaction temperature to 180° C. or lower, thereby simplifying a purification step after the termination of reaction.

A reaction pressure in the method of producing the component (A) is not particularly limited as long as a predetermined reaction temperature can be maintained. The reaction may be conducted under reduced pressure or pressurized conditions. The reaction pressure is usually from 0.000001 to 10 MPa (absolute pressure).

In the method of producing the component (A), as a transesterification proceeds, a monovalent alcohol derived from the monofunctional (meth)acrylate is produced as a by-product. The monovalent alcohol may be allowed to coexist in the reaction system. However, progress in the transesterification can be further promoted by discharging the monovalent alcohol outside of the reaction system.

It is also possible to conduct the reaction without using solvents in the method of producing the component (A). Solvents may be used, if necessary.

Specific examples of the solvents include: hydrocarbons such as n-hexane, cyclohexane, methylcyclohexane, n-heptane, n-octane, n-nonane, n-decane, benzene, toluene, xylene, ethylbenzene, diethylbenzene, isopropylbenzene, amylbenzene, diamylbenzene, triamylbenzene, dodecylbenzene, didodecylbenzene, amyltoluene, isopropyltoluene, decalin, or tetralin; ethers such as diethylether, dipropylether, diisopropylether, dibutylether, diamylether, diethylacetal, dihexylacetal, t-butylmethylether, cyclopentylmethylether, tetrahydrofuran, tetrahydropyran, trioxane, dioxane, anisole, diphenylether, dimethylcellosolve, diglyme, triglyme, or tetraglyme; crown ethers such as 18-crown-6; esters such as methyl benzoate or γ-butyrolactone; ketones such as acetone, methylethylketone, methylisobutylketone, cyclohexanone, acetophenone, or benzophenone; carbonate compounds such as dimethyl carbonate, diethyl carbonate, ethylene carbonate, propylene carbonate, or 1,2-butylene carbonate; sulfones such as sulfolane; sulfoxides such as dimethyl sulfoxide; ureas or derivatives thereof; ionic liquids of phosphine oxides such as tributylphosphine oxide, imidazolium salts, piperidinium salts, or pyridinium salts; silicon oil; and water.

Among these solvents, hydrocarbons, ethers, carbonate compounds, and ionic liquids are preferable.

The solvent may be used singly, or in any combination of two or more kinds thereof as a mixed solvent.

In the method of producing the component (A), an inert gas such as argon, helium, nitrogen, or carbon dioxide gas may be introduced into the system in order to favorably maintain the color tone of the reaction solution. An oxygen-containing gas may be introduced into the system in order to prevent polymerization of (meth)acryloyl groups.

Specific examples of an oxygen-containing gas include air, a mixed gas of oxygen and nitrogen, and a mixed gas of oxygen and helium. As a method of introducing the oxygen-containing gas, a method of dissolving a gas in a reaction solution or infusing (i.e., bubbling) a gas into a reaction solution is employed.

In the method of producing the component (A), it is preferable to add a polymerization inhibitor into the reaction solution in order to prevent polymerization of (meth)acryloyl groups.

Specific examples of the polymerization inhibitor include: an organic polymerization inhibitor such as hydroquinone, tert-butyl hydroquinone, hydroquinone monomethylether, 2,6-di-tert-butyl-4-methylphenol, 2,4,6-tri-tert-butylphenol, 4-tert-butylcatechol, benzoquinone, phenothiazine, N-nitroso-N-phenylhydroxyamine ammonium, 2,2,6,6-tetramethylpiperidine-1-oxyl, or 4-hydroxy-2,2,6,6-tetramethylpiperidine-1-oxyl; an inorganic polymerization inhibitor such as copper chloride, copper sulfate, or iron sulfate; and an organic salt-based polymerization inhibitor such as copper dibutyldithiocarbamate or N-nitroso-N-phenylhydroxyamine aluminum salt.

The polymerization inhibitor may be added singly, or in any combination of two or more kinds thereof. The polymerization inhibitor may be added at the beginning of or in the middle of the invention. In addition, the desired amount of the polymerization inhibitors used may be added at once or in divided portions, or may be added continuously via a rectifier.

A proportion of the polymerization inhibitor to be added is preferably from 5 to 30,000 wt ppm and more preferably from 25 to 10,000 wt ppm in the reaction solution. When the proportion is set to 5 wt ppm or more, polymerization inhibition effects can be obtained. When the proportion is set to 30,000 wt ppm or less, coloring of the reaction solution can be prevented, and the purification step after the termination of reaction can be simplified. In addition, reduction of the curing rate of the obtained component (A) can be prevented.

A reaction time in the method of producing the component (A) varies depending on types of catalysts, amounts of catalysts used, reaction temperature, reaction pressure, or the like. The reaction time is usually from 0.1 to 150 hours and preferably from 0.5 to 80 hours.

The method of producing the component (A) can be carried out by any of batch-type, semi-batch-type, and continuous-type methods. One example of the batch-type method can be carried out by introducing a polyalcohol, a monofunctional (meth)acrylate, a catalyst, and a polymerization inhibitor into a reactor, stirring a reaction solution while bubbling with an oxygen-containing gas at a predetermined temperature, followed by discharging a monovalent alcohol obtained as a by-product with progress of the transesterification under a predetermined pressure from the reactor, thereby producing the component (A) of interest.

It is preferable to perform a separation/purification operation on a reaction product obtained in the method of producing the component (A) since GLY-TA of interest can be obtained with sufficient purity.

Examples of the separation/purification operation include a crystallization operation, a filtration operation, a distillation operation, and an extraction operation. It is preferable to combine these operations. Examples of the crystallization operation include cool crystallization and condensation crystallization. Examples of the filtration operation include pressurized filtration, suction filtration, and centrifugal filtration. Examples of the distillation operation include single distillation, fractional distillation, molecular distillation, and steam distillation. Examples of the extraction operation include solid-liquid extraction and liquid-liquid extraction.

Solvents may be used in the separation/purification operation. It is also possible to use a neutralizer for neutralizing catalysts and/or polymerization inhibitors used in the invention, adsorbents for removing the same by adsorption, acid and/or alkali for decomposing or removing by-products, activated carbon for improving the color tone, diatomaceous earth for improving filtration efficiency and the filtration rate, and the like.

2. Component (B)

The component (B) is a (meth)acrylic oligomer, a urethane adduct, or a combination thereof.

A molecular weight of the (meth)acrylic oligomer is preferably from 600 to 30,000 and more preferably from 600 to 20,000 in terms of weight-average molecular weight (hereinafter referred to as “Mw”).

Mw in the invention refers to a value obtained by converting a molecular weight measured by GPC with reference to a molecular weight of polystyrene.

Various compounds can be used as the (meth)acrylic oligomer as long as they have two or more (meth)acryloyl groups and satisfy the above-described molecular weight. Examples of a preferred compound include a urethane (meth)acrylate, an epoxy(meth)acrylate, and a polyester(meth)acrylate.

Further, the component (B) is more preferably a urethane (meth)acrylate or an epoxy(meth)acrylate. A urethane (meth)acrylate and an epoxy(meth)acrylate are highly effective for decrease in viscosity, since viscosity thereof increases if blended in a composition.

The urethane (meth)acrylate, the epoxy(meth)acrylate, the polyester(meth)acrylate, and the urethane adduct are described below.

2-1. Urethane (meth)acrylate

The urethane (meth)acrylate can be obtained by a reaction of a polyalcohol, an organic polyisocyanate, and a hydroxy group-containing (meth)acrylate compound.

Examples of the polyalcohol include a polyether polyol such as polypropylene glycol or polytetramethylene glycol, a polyester polyol obtained by a reaction of the above-described polyalcohol and the above-described polybasic acid, a caprolactone polyol obtained by a reaction of the above-described polyalcohol, the above-described polybasic acid, and ε-caprolactone, and a polycarbonate polyol (e.g., a polycarbonate polyol obtained by a reaction of 1,6-hexanediol and diphenylcarbonate).

Examples of the organic polyisocyanate include a diisocyanats such as isophorone diisocyanate, hexamethylene diisocyanate, tolylene diisocyanate, xylylene diisocyanate, diphenylmethane-4,4′-diisocyanate, and dicyclopentanyl diisocyanate; and an organic polyisocyanate having three or more isocyanate groups such as a hexamethylene diisocyanate trimer and an isophorone diisocyanate trimer.

Examples of the hydroxy group-containing (meth)acrylate include: a hydroxy group-containing mono(meth)acrylate such as 2-hydroxyethyl(meth)acrylate, 2-hydroxypropyl(meth)acrylate, hydroxybutyl(meth)acrylate, hydroxypentyl(meth)acrylate, hydroxyhexyl(meth)acrylate and hydroxyoctyl(meth)acrylate, trimethylolpropane mono(meth)acrylate, glycerin mono(meth)acrylate, and pentaerythritol mono(meth)acrylate; and a hydroxy group-containing polyfunctional(meth)acrylate such as trimethylolpropane di(meth)acrylate, glycerin di(meth)acrylate, pentaerythritol di or tri(meth)acrylate, di or tri(meth)acrylate of ditrimethylolpropane, or di, tri, tetra or penta(meth)acrylate of dipentaerythritol.

As the urethane (meth)acrylate, those obtained using the compound by an ordinary method can be used.

Specifically, the urethane (meth)acrylate can be obtained by conducting an addition reaction of an organic isocyanate and a polyol component to be used by stirring and heating under the presence of an addition catalyst such as dibutyltin dilaurate, adding hydroxyalkyl(meth)acrylate, and further conducting an addition reaction by stirring and heating.

Examples of urethane poly(meth)acrylates other than the above include the compounds described in the document, for example, “Technology of UV/EB Curing V” (published in 1992 by CMC Publishing Co., Ltd., pages from 70 to 74).

2-2. Epoxy(meth)acrylate

Epoxy(meth)acrylates are compounds obtained by an addition reaction in which (meth)acrylic acid is added to epoxy resins. Examples thereof include the compounds described in the document “Technology of UV/EB Curing V” (pages from 74 to 75).

Examples of the epoxy resin include an aromatic epoxy resin and an aliphatic epoxy resin.

Specific examples of the aromatic epoxy resin include: resorcinol diglycidylether; di or polyglycidylether of bisphenol A, bisphenol F, bisphenol S, bisphenol fluorene, or an alkylene oxide adduct thereof; a novolac-type epoxy resin such as a phenol novolac-type epoxy resin or a cresol novolac-type epoxy resin; glycidylphthalimide; and o-diglycidyl phthalate.

In addition to the above, various compounds described in the document “Recent Progress in Epoxy Resins” (published in 1990 by Shokodo Co., Ltd., Chapter 2) and the document “Polymer Application” (additional volume 9, vol. 22, extra edition, “Epoxy Resin”) (published in 1973 by Kobunshi Kankokai, pages from 4 to 6 and from 9 to 16) can be employed.

Examples of the aliphatic epoxy resin include a diglycidyl ether of an alkylene glycol such as ethylene glycol, propyleneglycol, 1,4-butanediol, or 1,6-hexanediol; a diglycidyl ether of a polyalkylene glycol such as a diglycidyl ether of polyethylene glycol or polypropylene glycol; a diglycidyl ether of neopentyl glycol, dibromoneopentyl glycol, or an alkylene oxide adduct thereof; a polyglycidyl ether of a polyalcohol such as di or triglycidyl ether of trimethylolethane, trimethylolpropane, glycerin, or an alkylene oxide adduct thereof or di, tri or tetraglycidyl ether of pentaerythritol or an alkylene oxide adduct thereof; di or polyglycidyl ether of a hydrogenated bisphenol A or an alkyleneoxide adduct thereof; tetrahydrophthalic diglycidyl ether; and hydroquinone diglycidyl ether.

In addition to the above, the compounds described in the above-described document “Polymer Application” (additional volume: “Epoxy Resin”, pages from 3 to 6) can be employed.

In addition to these aromatic epoxy resins and aliphatic epoxy resins, an epoxy compound having a triazine nucleus in its skeleton such as TEPIC (Nissan Chemical Industries, Ltd.) or DENACOL EX-310 (Nagase Chemicals, Ltd.) can be employed, and the compounds described in the document “Polymer Application” (additional volume: “Epoxy Resin,” pages from 289 to 296) can also be employed.

Among the above, ethylene oxide, propylene oxide, and the like are preferable as an alkylene oxide of the alkylene oxide adduct.

2-3. Polyester(meth)acrylate Examples of the polyester(meth)acrylate include a product of dehydration condensation of a polyester polyol and (meth)acrylic acid.

Examples of the polyester polyol include a reaction product of a polyol and a carboxylic acid or an anhydride thereof.

Examples of the polyol include a low-molecular-weight polyol such as ethylene glycol, diethylene glycol, triethylene glycol, tetraethylene glycol, polyethylene glycol, propylene glycol, dipropylene glycol, tripropylene glycol, polypropylene glycol, butylene glycol, polybutylene glycol, tetramethylene glycol, hexamethylene glycol, neopentyl glycol, cyclohexanedimethanol, 3-methyl-1,5-pentanediol, 1,6-hexanediol, trimethylol propane, glycerin, pentaerythritol, or dipentaerythritol, and an alkylene oxide adduct thereof.

Examples of the carboxylic acid or the anhydride thereof include a dibasic acid such as orthophthalic acid, isophthalic acid, terephthalic acid, adipic acid, succinic acid, fumaric acid, maleic acid, hexahydrophthalic acid, tetrahydrophthalic acid, or trimellitic acid, and an anhydride thereof.

Examples of a polyesterpoly(meth)acrylate other than the above include the compounds described in the document “Technology of UV/EB Curing V” (pages from 74 to 76).

2-4. Urethane Adduct

A urethane adduct is a reaction product of an organic polyisocyanate and a hydroxy group-containing (meth)acrylate.

In a urethane adduct, examples of the organic polyisocyanate and the hydroxy group-containing (meth)acrylate compound include the above-described compounds.

It is preferable to use a hydroxy group-containing polyfunctional(meth)acrylate as the hydroxy group-containing (meth)acrylate in a urethane adduct.

Among these, a compound having three or more (meth)acryloyl groups and one hydroxy group is preferable in terms of excellent hardness and scratch resistance of a cured product. Specific examples thereof include pentaerythritol tri(meth)acrylate, ditrimethylolpropanetri(meth)acrylate, and dipentaerythritol penta(meth)acrylate.

Examples of a preferred compound as a urethane adduct other than the above include a reaction product of an organic polyisocyanate having three or more isocyanate groups and a hydroxy group-containing mono(meth)acrylate.

Examples of the hydroxy group-containing mono(meth)acrylate include compounds similar to the above-described compounds.

Examples of the organic polyisocyanate having three or more isocyanate groups include the above-described hexamethylene diisocyanate trimer and isophorone diisocyanate trimer.

3. Curable Composition

The invention relates to a curable composition including the above-described components (A) and (B).

A method of producing the composition may be carried out in accordance with an ordinary method. The composition can be obtained by mixing and stirring the components (A) and (B) and, if necessary, other components described below.

Further, as the method of producing the composition, a method of producing a curable composition, including: a step of producing a (meth)acrylate mixture (A) including, as a main component, GLY-TA, which is obtained by carrying out transesterification of glycerin and a monofunctional (meth)acrylate under the presence of the catalysts X and Y; and a step of stirring and mixing the obtained components (A) and (B), is preferable.

According to the production method, the component (A) can be produced at a high yield. In addition, since the obtained component (A) includes a small amount of a high-molecular-weight body, the component has low viscosity and includes few impurities. Therefore, the obtained composition has various excellent properties, which is preferable.

The steps may be carried out in accordance with the above-described method of producing the component (A).

A content percentage of the components (A) and (B) are preferably from 10% to 70% by weight and from 30% to 90% by weight, and more preferably from 10% to 60% by weight and 40 to 90% by weight, respectively, with respect to 100% by weight in total of the components (A) and (B).

By setting the content percentage of the component (A) to 10% by weight or more, or the content percentage of the component (B) to 90% by weight or less, viscosity of the composition can be lowered, thereby achieving excellent coating performance or appearance of a cured product. By setting the content percentage of the component (A) to 70% by weight or less, or the content percentage of the component (B) to 30% by weight or more, a cured product having excellent hardness and scratch resistance can be obtained.

Viscosity of the composition may be appropriately set depending on purposes.

In a case in which the composition of the invention is used as a coating agent, the viscosity is preferably 100 to 5,000 mPa·s and more preferably 100 to 4,000 mPa·s. By setting the viscosity within the range, it is possible to improve leveling property of the composition and improve a cured film appearance.

The term “viscosity” in the invention means a value measured using a type E viscometer at 25° C.

The composition of the invention can be used for both of an active energy beam-curable composition and a thermosetting composition. The active energy beam-curable composition is preferable.

The composition of the invention includes the above-described components (A) and (B) as essential components. However, various components can be mixed therewith depending on purposes.

Specifically, examples of other components include a photopolymerization initiator (hereinafter referred to as a “component (C)”), a thermal polymerization initiator (hereinafter referred to as a “component (D)”), a compound having an ethylenically unsaturated group other than the components (A) and (B) (hereinafter referred to as a “component (E)”), an organic solvent (hereinafter referred to as a “component (F)”), and an antioxidant, an ultraviolet absorber, a pigment/a dye, a leveling agent, a silane coupling agent, a surface modifier, a polymer, and a polymerization inhibitor.

These components are explained below.

As the other components described below, the exemplified compound may be used singly, or in combination of two or more kinds thereof.

1) Component (C)

In a case in which the composition of the invention is used as an active energy beam-curable composition and is further used as an electron beam-curable composition, it is also possible to allow the composition not to include the component (C) (photopolymerization initiator) so as to be cured by an electron beam.

In a case in which the composition of the invention is used as an active energy beam-curable composition especially using ultraviolet ray and visible ray as an active energy beam, it is preferable for the composition to further include the component (C) in view of the ease of curing and cost.

In a case in which an electron beam is used as an active energy beam, it is not always necessary to blend the component (C). However, it is possible to blend a small amount of the component (C) in order to improve cuing, if necessary.

Specific examples of the component (C) include: an acetophenone-based compound such as benzyldimethylketal, 1-hydroxycyclohexylphenylketone, 2-hydroxy-2-methyl-1-phenylpropane-1-one, 1-[4-(2-hydroxyethoxy)phenyl]-2-hydroxy-2-methyl-1-propane-1-one, oligo[2-hydroxy-2-methyl-1-[4-1-(methylvinyl)phenyl]propanone, 2-hydroxy-1-[4-[4-(2-hydroxy-2-methyl-propionyl)benzyl]phenyl]-2-methylpropane-1-one, 2-methyl-1-[4-(methylthio)]phenyl]-2-morpholinopropane-1-one, 2-benzyl-2-dimethylamino-1-(4-morpholinophenyl)butane-1-one, 2-dimethylamino-2-(4-methylbenzyl)-1-(4-morpholine-4-yl-phenyl)butane-1-one, or 3,6-bis(2-methyl-2-morpholinopropionyl)-9-n-octylcarbazole; a benzoin compound such as benzoin, benzoin ethylether, benzoin isopropylether, or benzoin isobutylether; a benzophenone-based compound such as benzophenone, 2-methylbenzophenone, 3-methylbenzophenone, 4-methylbenzophenone, 2,4,6-trimethylbenzophenone, 4-phenylbenzophenone, methyl-2-benzophenone, 1-[4-(4-benzoylphenylsulfanyl)phenyl]-2-methyl-2-(4-methylphenylsulfonyl)propane-1-one, 4,4′-bis(dimethylamino)benzophenone, 4,4′-bis(diethylamino)benzophenone, or 4-methoxy-4′-dimethylaminobenzophenone; an acyl phosphine oxide compound such as bis(2,4,6-trimethylbenzoyl)phenylphosphine oxide, 2,4,6-trimethylbenzoyldiphenylphosphine oxide, or bis(2,6-dimethoxybenzoyl)-2,4,4-trimethylpentylphosphine oxide; and a thioxanthone-based compound such as thioxanthone, 2-chlorothioxanthone, 2,4-diethylthioxanthone, isopropylthioxanthone, 1-chloro-4-propylthioxanthone, 3-[3,4-dimethyl-9-oxo-9H-thioxanthone-2-yl-oxy]-2-hydroxypropyl-N,N,N-trimethylammonium chloride, or fluorothioxanthone.

Examples of compounds other than the above include benzyl, phenylglyoxylate methyl, ethyl(2,4,6-trimethylbenzoyl)phenylphosphinate, ethylanthraquinone, phenanthrenequinone, and camphorquinone.

Among these compounds, α-hydroxyphenylketones are preferable since surface curing ability is excellent in the atmosphere even for thin film coating. Specifically, 1-hydroxycyclohexylphenylketone and 2-hydroxy-2-methyl-1-phenyl-propane-1-one are more preferable.

In addition, in a case in which it is necessary to increase a film thickness of a cured film to, for example, 50 μm or greater, or in a case in which ultraviolet absorbers and pigments are used in combination in order to improve curing inside of a cured product, an acyl phosphine oxide compound such as bis(2,4,6-trimethylbenzoyl)-phenylphosphine oxide, 2,4,6-trimethylbenzoyldiphenylphosphine oxide, or bis(2,6-dimethoxybenzoyl)-2,4,4-trimethylpentylphosphine oxide, and 2-methyl-1-[4-(methylthio)]phenyl]-2-morpholinopropane-1-one, 2-benzyl-2-dimethylamino-1-(4-morpholinophenyl)butane-1-one, 2-dimethylamino-2-(4-methylbenzyl)-1-(4-morpholine-4-yl-phenyl)-butane-1-one, or the like are preferably used in combination.

A content percentage of the component (C) is preferably from 0.1 to 10 parts by weight and more preferably from 0.5 to 8 parts by weight, with respect to 100 parts by weight in total of a curable component. By setting the content percentage of the component (C) to 0.1 part by weight or more, the composition is allowed to have favorable photocurability and excellent adhesiveness. By setting the content percentage of the component (C) to 10 parts by weight or less, favorable curing inside of a cured product is achieved, thereby improving adhesion to a substrate.

The term “curable component” in the invention means a component that is cured with heat or an active energy beam. The term refers to the components (A) and (B), and it refers to the components (A), (B), and (E) in a case in which the component (E) described below is blended.

2) Component (D)

The component (D) is a thermal polymerization initiator. In a case in which the composition is used as a thermosetting composition, the component (D) can be blended therewith.

Various compounds can be used as thermal polymerization initiators. An organic peroxide and an azo-based initiator are preferable.

Specific examples of the organic peroxide include 1,1-bis(t-butylperoxy) 2-methylcyclohexane, 1,1-bis(t-hexylperoxy)-3,3,5-trimethylcyclohexane, 1,1-bis(t-hexylperoxy)cyclohexane, 1,1-bis(t-butylperoxy)-3,3,5-trimethylcyclohexane, 1,1-bis(t-butylperoxy)cyclohexane, 2,2-bis(4,4-di-butylperoxycyclohexyl)propane, 1,1-bis(t-butylperoxy)cyclododecane, t-hexylperoxyisopropyl monocarbonate, t-butylperoxymaleic acid, t-butylperoxy-3,5,5-trimethylhexanoate, t-butylperoxylaurate, 2,5-dimethyl-2,5-di(m-toluoylperoxy)hexane, t-butylperoxyisopropyl monocarbonate, t-butylperoxy2-ethylhexylmonocarbonate, t-hexylperoxybenzoate, 2,5-di-methyl-2,5-di(benzoylperoxy)hexane, t-butylperoxyacetate, 2,2-bis(t-butylperoxy)butane, t-butylperoxybenzoate, n-butyl-4,4-bis(t-butylperoxy)valerate, di-t-butylperoxyisophthalate, α,α′-bis(t-butylperoxy)diisopropylbenzene, dicumyl peroxide, 2,5-dimethyl-2,5-di(t-butylperoxy)hexane, t-butylcumyl peroxide, di-t-butyl peroxide, p-menthane hydroperoxide, 2,5-dimethyl-2,5-di(t-butylperoxy)hexine-3, diisopropylbenzene hydroperoxide, t-butyltrimethylsilyl peroxide, 1,1,3,3-tetra methylbutyl hydroperoxide, cumene hydroperoxide, t-hexyl hydroperoxide, or t-butyl hydroperoxide.

Specific examples of the azo-based compound include 1,1′-azobis(cyclohexane-1-carbonitrile), 2-(carbamoylazo)isobutyronitrile, 2-phenylazo-4-methoxy-2,4-dimethylvaleronitrile, azo-di-t-octane, or azo-di-t-butane.

They may be used singly, or in combination of two or more kinds thereof. The organic peroxide may be used in combination with a reductant in redox reaction.

Amounts of these thermal polymerization initiators used are preferably 10 parts by weight or less with respect to 100 parts by weight in total of the curable component.

In a case in which a thermal polymerization initiator is used singly, it can be used in accordance with ordinary means of usual radical thermal polymerization. In some cases, it is also possible to use a thermal polymerization initiator in combination with a component (C) (photopolymerization initiator) and conduct photo-curing and then further conduct thermal curing in order to improve the reaction rate.

3) Component (E)

The component (E) is an ethylenically unsaturated compound other than the components (A) and (B) and it is blended in order to impart various properties to a cured product of the composition.

Examples of the ethylenically unsaturated groups in the component (E) include a (meth)acryloyl group, a (meth)acrylamide group, a vinyl group, and a (meth)allyl group, and the (meth)acryloyl group is preferable.

The term “monofunctional” used hereinafter refers to a compound having one ethylenically unsaturated group, the term “x-functional” refers to a compound, of which the number of ethylenically unsaturated groups is x, and the term “polyfunctional” refers to a compound having two or more ethylenically unsaturated groups.

Regarding the component (E), specific examples of the monofunctional ethylenically unsaturated compound include compounds similar to the above-described monofunctional (meth)acrylates. Methyl(meth)acrylate, ethyl(meth)acrylate, butyl(meth)acrylate, 2-ethylhexyl(meth)acrylate, cyclohexyl(meth)acrylate, tert-butylcyclohexyl(meth)acrylate, and 2-methoxyethylacrylate are preferable.

Examples of compounds other than the above-described monofunctional (meth)acrylates include a Michael addition-type dimer of (meth)acrylic acid or acrylic acid, o-carboxy-polycaprolactone mono(meth)acrylate, phthalic acid monohydroxyethyl(meth)acrylate, ethylcarbitol(meth)acrylate, butylcarbitol(meth)acrylate, 2-ethylhexylcarbitol(meth)acrylate, benzyl(meth)acrylate, phenyl(meth)acrylate, (meth)acrylate of a phenol alkylene oxide adduct, (meth)acrylate of an alkylphenol alkylene oxide adduct, 2-hydroxyethyl(meth)acrylate, 2-hydroxypropyl(meth)acrylate, 4-hydroxybutylacrylate, (meth)acrylate of a paracumylphenol alkylene oxide adduct, orthophenylphenol(meth)acrylate, (meth)acrylate of an orthophenylphenol alkylene oxide adduct, tetrahydrofurfuryl(meth)acrylate, isobornyl(meth)acrylate, tricyclodecanemethylol(meth)acrylate, 2-hydroxy-3-phenoxypropyl(meth)acrylate, N-(2-(meth)acryloyloxyethyl)hexahydrophthalimide, N-(2-(meth)acryloyloxyethyl)tetrahydrophthalimide, N,N-dimethylacrylamide, acryloyl morpholine, N-vinyl pyrrolidone, or N-vinyl caprolactam.

Specific examples of a bifunctional (meth)acrylate compound include a polyethylene glycol di(meth)acrylate, ethylene glycol di(meth)acrylate, a polypropylene glycol di(meth)acrylate, propylene glycol di(meth)acrylate, tetramethylene glycol di(meth)acrylate, a polytetramethylene glycol di(meth)acrylate, di(meth)acrylate of a bisphenol A alkylene oxide adduct, di(meth)acrylate of a bisphenol F alkylene oxide adduct, butanediol di(meth)acrylate, hexanediol di(meth)acrylate, and nonanediol di(meth)acrylate.

Examples of a trifunctional or higher functional (meth)acrylate compound include various compounds as long as the compounds each have three or more (meth)acryloyl groups. Examples thereof include: a polyol poly(meth)acrylate such as trimethylolpropane tri(meth)acrylate, tri or tetra(meth)acrylate of pentaerythritol, tri or tetra(meth)acrylate of ditrimethylolpropane, tri or tetra(meth)acrylate of diglycerin, or tri, tetra, penta or hexa(meth)acrylate of dipentaerythritol;

a poly(meth)acrylate of a polyol alkylene oxide adduct such as tri(meth)acrylate of a glycerin alkylene oxide adduct, tri or tetra(meth)acrylate of a pentaerythritol alkylene oxide adduct, tri or tetra(meth)acrylate of a ditrimethylolpropane alkylene oxide adduct, tri or tetra(meth)acrylate of a diglycerin alkylene oxide adduct, or tri, tetra, penta or hexa(meth)acrylate of a dipentaerythritol alkylene oxide adduct; and tri(meth)acrylate of an isocyanuric acid alkylene oxide adduct.

Examples of the alkylene oxide adduct described above include an ethylene oxide adduct, a propylene oxide adduct, and an ethylene oxide-propylene oxide adduct.

A content percentage of the component (E) is preferably from 0% to 60% by weight and more preferably 0% to 30% by weight, with respect to 100 parts by weight in total of a curable component.

By setting the content percentage of the component (E) to 60% by weight or less, it is possible to prevent a cured product from being breakable in a particular case of using the polyfunctional ethylenically unsaturated compound.

4) Component (F)

The component (F) is an organic solvent, which is blended in order to, for example, reduce viscosity of a composition and improve coating ability on a substrate.

Specific examples of the component (F) include: an alcohol compound such as methanol, ethanol, isopropanol, or butanol; an alkylene glycol monoether compound such as ethylene glycol monomethylether or propylene glycol monomethylether; an acetone alcohol such as diacetone alcohol; an aromatic compound such as benzene, toluene, or xylene; an ester compounds such as propylene glycol monomethylether acetate, ethyl acetate, or butyl acetate; a ketone compound such as acetone, methylethylketone, or methylisobutylketone; an ether compound such as dibutylether; and N-methylpyrrolidone.

Among these, the alkylene glycol monoether compound and the ketone compound are preferable, and the alkylene glycol monoether compound is more preferable.

A content percentage of the component (F) is preferably from 10 to 1,000 parts by weight, more preferably from 50 to 500 parts by weight, and still more preferably 50 to 300 parts by weight, with respect to 100 parts by weight in total of a curable component.

When the content percentage is within the above range, a composition having viscosity appropriate for coating can be obtained, and the composition can be readily coated by a conventionally known application method described below.

5) Antioxidant

An antioxidant is blended in order to improve durability such as heat resistance or weather resistance of a cured product.

Examples of the antioxidant include a phenol-based antioxidant, a phosphorus-based antioxidant, and a sulfur-based antioxidant.

Examples of the phenol-based antioxidants include a hindered phenol such as di-t-butylhydroxytoluene. Examples of a commercially available antioxidant include AO-20, AO-30, AO-40, AO-50, AO-60, AO-70, and AO-80, manufactured by ADEKA Corporation.

Examples of the phosphorus-based antioxidant include a phosphine such as a trialkyl phosphine or a triaryl phosphine, a trialkyl phosphite, and a triaryl phosphite. Examples of their derivatives as commercially available products include ADK STAB PEP-4C, PEP-8, PEP-24G, PEP-36, HP-10, 260, 522A, 329K, 1178, 1500, 135A, and 3010 manufactured by ADEKA Corporation.

Examples of the sulfur-based antioxidant include a thioether-based compounds. Examples of commercially available products include AO-23, AO-412S, and AO-503A manufactured by ADEKA Corporation.

These may be used singly, or in combination of two or more kinds thereof. Examples of a preferable combination of these antioxidants include a combination of the phenol-based antioxidant and the phosphorus-based antioxidant and a combination of the phenol-based antioxidant and the sulfur-based antioxidant.

A content percentage of the antioxidant can be appropriately set depending on purposes. The content percentage is preferably from 0.01 to 5 parts by weight and more preferably from 0.1 to 1 part by weight, with respect to 100 parts by weight in total of a curable component.

By setting the content percentage to 0.1 part by weight or more, durability of a composition can be improved. By setting the content percentage to 5 parts by weight or less, favorable curing ability and adhesiveness can be achieved.

6) Ultraviolet Absorber

An ultraviolet absorber is blended in order to improve light resistance of a cured product.

Examples of the ultraviolet absorber include a triazine-based ultraviolet absorber such as TINUVIN400, TINUVIN405, TINUVIN460, or TINUVIN479 and a benzotriazole-based ultraviolet absorber such as TINUVIN900, TINUVIN928, or TINUVIN1130, manufactured by BASF SE.

A content percentage of the ultraviolet absorber can be appropriately set depending on purposes. The content percentage is preferably from 0.01 to 5 parts by weight and more preferably from 0.1 to 1 part by weight, with respect to 100 parts by weight in total of a curable component. By setting the content percentage to 0.01% by weight or more, a cured product is allowed to have favorable light resistance. By setting the content percentage to 5% by weight or less, a composition is allowed to have excellent curing ability.

7) Pigment/Dye

Examples of a pigment include an organic pigment and inorganic pigment.

Specific examples of the organic pigment include: an insoluble azo pigment such as toluidine red, toluidine maroon, hansa yellow, benzidine yellow, or pyrazolone red; a soluble azo pigment such as lithol red, helio-Bordeaux, pigment scarlet, or permanent red 2B; a derivative from a vat dye such as alizarin, indanthrone, or thioindigo maroon; a phthalocyanine-based organic pigment such as phthalocyanine blue or phthalocyanine green; a quinacridone-based organic pigment such as quinacridone red or quinacridone magenta; a perylene-based organic pigment such as perylene red or perylene scarlet; an isoindolinone-based organic pigment such as isoindolinone yellow or isoindolinone orange; a pyranthrone-based organic pigment such as pyranthrone red or pyranthrone orange; a thioindigo-based organic pigment; a condensed azo-based organic pigment; a benzimidazolone-based organic pigment; a quinophthalone-based organic pigment such as quinophthalone yellow; an isoindoline-based organic pigment such as isoindoline yellow; and other pigments such as flavanthron yellow, acyl amide yellow, nickel azo yellow, copper azomethine yellow, perinone orange, anthrone orange, dianthraquinonyl red, or dioxazine violet.

In addition, specific examples of the inorganic pigment include titanium oxide, barium sulfate, calcium carbonate, zinc flower, lead sulfate, yellow lead, zinc yellow, rouge (red iron oxide (III)), cadmium red, ultramarine, iron blue, chromic oxide green, cobalt green, amber, titanium black, and synthetic iron oxide black. Carbon black exemplified as the above-described filler can also be used as an inorganic pigment.

Various conventionally known compounds can be used as dyes.

8) Silane Coupling Agent

A silane coupling agent is blended in order to improve interfacial adhesion forth between a cured product and a substrate.

A silane coupling agent is not particularly limited as long as it can contribute to adhesion to a substrate.

Specific examples of the silane coupling agent include 2-(3,4-epoxy cyclohexyl)ethyltrimethoxysilane, 3-glycidoxypropyltrimethoxysilane, 3-glycidoxypropylmethyldiethoxysilane, 3-glycidoxypropyltriethoxysilane, N-2-(aminoethyl)-3-aminopropylmethyldimethoxysilane, N-2-(aminoethyl)-3-aminopropyltrimethoxysilane, N-2-(aminoethyl)-3-aminopropyltriethoxysilane, 3-aminopropyltrimethoxysilane, 3-aminopropyltriethoxysilane, 3-triethoxysilyl-N-(1,3-dimethyl-butylidene)propylamine, N-phenyl-3-aminopropyltrimethoxysilane, 3-mercaptopropylmethyldimethoxysilane, and 3-mercaptopropyltrimethoxysilane.

A blending amount of the silane coupling agent can be appropriately set depending on purposes. The blending amount is preferably from 0.1 to 10 parts by weight and more preferably from 1 to 5 parts by weight, with respect to 100 parts by weight in total of a curable component.

By setting the blending amount to 0.1 part by weight or more, the adhesion force of a composition can be improved. By setting the blending amount to 10 parts by weight or less, time-dependent changes in adhesion force can be prevented.

9) Surface Modifier

A surface modifier may be added to the composition of the invention in order to, for example, improve a leveling property when coating, or improve slidability of a cured product thereby improving scratch resistance.

Examples of the surface modifier include a surface conditioning agent, a surfactant, a leveling agent, an antifoamer, a slidability-imparting agent and an antifouling property-imparting agent. These conventionally known surface modifiers can be used.

Among these, a silicone-based surface modifier and fluorine-based surface modifier are favorable examples. Specific examples include a silicone-based polymer and oligomer each having a silicone chain and a polyalkylene oxide chain, a silicone-based polymer and oligomer each having a silicone chain and a polyester chain, a fluorine-based polymer and oligomer each having a perfluoroalkyl group and a polyalkylene oxide chain, and a fluorine-based polymer and oligomer each having a perfluoroalkyl ether chain and a polyalkylene oxide chain.

In addition, in order to, for example, increase ability to maintain slidability, a surface modifier having an ethylenically unsaturated group, preferably a (meth)acryloyl group in its molecule may be used.

A content percentage of the surface modifier is preferably from 0.01 to 1.0 part by weight with respect to 100 parts by weight in total of a curable component. Excellent surface smoothness of a coating film can be achieved within the above range.

10) Polymer

The composition of the invention may further include a polymer in order to, for example, further improve resistance to curling of a cured product to be obtained.

Examples of a favorable polymer include a (meth)acrylic-based polymer. Examples of a favorable monomer that constitutes the polymer include methyl(meth)acrylate, cyclohexyl (meth)acrylate, (meth)acrylic acid, glycidyl (meth)acrylate, and N-(2-(meth)acryloxyethyl)tetrahydrophthalimide. In a case where the polymer is obtained by copolymerizing (meth)acrylic acid, a (meth)acryloyl group may be introduced into a polymer chain by adding glycidyl (meth)acrylate.

A content percentage of the polymer is preferably from 0.01 to 10 parts by weight with respect to 100 parts by weight in total of a curable component. Further excellent resistance to curling of a cured product to be obtained can be achieved within the above range.

4. Purposes

The invention relates to a curable composition and can be used for various purposes. Specific examples of the purposes include coating agents, ink, and molding materials.

The composition of the invention has low viscosity and is excellent in terms of appearance, hardness, and scratch resistance of a cured product. Therefore, the composition can be preferably used as a coating composition. Such a coating composition can be used for plastic paints, wood paints, or the like.

The composition of the invention can be used preferably as an active energy beam-curable composition.

5. Using Method

A method of using the composition of the invention can be carried out in accordance with an ordinary method.

For example, a method in which, after the composition is applied to a substrate, active energy beam irradiation or heating is conducted to cure the composition.

Specifically, after, the composition is applied to a substrate of interest by a usual painting method, in the case of an active energy beam-curable composition, a method of curing by active energy beam irradiation is employed, and in the case of a thermosetting composition, a method of curing by heating is employed. When the composition is used for a molding material or the like, after the composition is injected into a predetermined mold form, in the case of an active energy beam-curable composition, a method of curing by active energy beam irradiation is employed, and in the case of a thermosetting composition, a method of curing by heating is employed.

As a method of active energy beam irradiation or heating, a usual method known as a conventional curing method can be employed.

In addition, it is also possible to employ a method in which the composition mixed with the component (C) (a photopolymerization initiator) and the component (D) (a thermal polymerization initiator) used in combination is irradiated with an active energy beam, followed by heating for curing, thereby improving adhesion to a substrate.

Substrates to which the composition of the invention can be applied include various materials such as plastics, wood, metals, inorganic materials, and paper. Plastics and wood are particularly preferable.

Specific examples of plastics include cellulose acetate resins such as polyvinyl alcohol, triacetyl cellulose, or diacetyl cellulose, acrylic resins, cyclic polyolefin resins including cyclic olefins as monomers, such as polyethylene terephthalate, polycarbonate, polyarylate, polyethersulfone, or norbornene, polyvinyl chloride, epoxy resins, and polyurethane resins.

Examples of wood include natural wood and synthetic wood.

Examples of metals include steel plate, metals such as aluminum or chromium, and metal oxides such as zinc oxide (ZnO) or indium tin oxide (ITO).

Examples of inorganic materials include glass, mortar, concrete, and stone material.

Among these, plastic substrates are particularly preferable.

Film thickness of a cured product of the composition with respect to a substrate may be appropriately determined depending on purposes. Thickness of a cured product may be selected depending on the application of a substrate to be used or a substrate having the produced cured product, however, is preferably from 1 to 500 μm and more preferably from 5 to 200 μm.

A method of coating the composition of the invention to a substrate may be appropriately determined depending on purposes. Examples thereof include a method of coating by a bar coater, an applicator, a doctor blade, a dip coater, a role coater, a spin coater, a flow coater, a knife coater, a comma coater, a reverse role coater, a die coater, a lip coater, a gravure coater, a microgravure coater, and an ink-jet system.

Examples of the active energy beam for curing the composition of the invention include ultraviolet ray, visible ray, and an electron beam. Ultraviolet ray is preferable.

Examples of an ultraviolet ray irradiation device include high-pressure mercury lamps, metal halide lamps, ultraviolet ray (UV) electrodeless lamps, and light-emitting diodes (LEDs).

Irradiation energy may be appropriately determined depending on the kind of active energy beam and the blending composition. In one example of the use of a high-pressure mercury lamp, irradiation energy in a UV-A range is preferably from 100 to 5,000 mJ/cm² and more preferably from 200 to 1,000 mJ/cm².

### EXAMPLES

The invention is described in more detail below with reference to the Examples and Comparative Examples.

Note that the term “part(s)” hereinafter refers to “part(s) by weight.”

### 1. Production Example

### 1) Production Example 1 (Production of GLY-TA1 by a Transesterification Method)

Into a 1 L flask equipped with a stirrer, a thermometer, a gas introducing tube, a rectifier, and a cooling tube, 63.60 parts (0.69 mol) of glycerin, 700.99 parts (5.39 mol) of 2-methoxyethylacrylate, 5.47 parts (0.05 mol) of DABCO as the catalyst X, 8.94 parts (0.05 mol) of zinc acetate as the catalyst Y, and 1.56 parts (2000 wt ppm with respect to a total weight of the added starting materials) of hydroquinone monomethylether were added. The obtained liquid was bubbled with an oxygen-containing gas (5% by volume of oxygen, 95% by volume of nitrogen).

While the liquid was stirred and heated at a reaction liquid temperature of from 105° C. to 130° C., a pressure in the reaction system was adjusted to from 110 to 760 mmHg, thereby discharging a liquid mixture of 2-methoxyethanol obtained as a by-product and 2-methoxyethylacrylate with progress of transesterification through the rectifier and the cooling tube from the reaction system. In addition, 2-methoxyethylacrylate was added to the reaction system in an amount equivalent to the number of parts by weight of the discharged liquid, as needed. The pressure in the reaction system was adjusted back to ordinary pressure 30 hours after the start of heating and stirring to finish discharging the liquid mixture.

The reaction solution was cooled to room temperature and the precipitate was separated by filtration. Thereafter, 1.0 part of aluminum silicate (KYOWAAD 700 (trade name), manufactured by Kyowa Chemical Industry Co., Ltd.) and 1.0 part of activated carbon (TAIKO S (trade name), manufactured by Futamura Chemical Co., Ltd.) were added to the filtrate. Reduced-pressure distillation was performed at a temperature of from 70° C. to 95° C. and a pressure of from 0.001 to 100 mmHg for 8 hours while the filtrate was bubbled with dry air. A distilled liquid including unreacted 2-methoxyethylacrylate was separated. 2.0 parts of diatomaceous earth (RADIOLITE (trade name), manufactured by Showa Chemical Industry Co., Ltd.) was added to the tank liquid and pressurized filtration was performed. The obtained filtrate was designated as a purified product.

Composition analysis of the purified product was conducted using a high-performance liquid chromatograph equipped with a UV detector. As a result, the purified product was confirmed to include glycerin triacrylate as a main component (hereinafter referred to as “GLY-TA1”). The yield of the purified product was 90%. A hydroxy value of the obtained purified product was measured in accordance with the following method. As a result, the hydroxy value was 17 mg KOH/g. Table 1 shows the results.

### 2) Production Examples 2 to 4 (Production of GLY-TA2 to GLY-TA4 by a Transesterification Method)

GLY-TA2 to GLY-TA4 were produced in accordance with the method described in Production Example 1, except that the compounds listed in Table 1 were used as the catalysts X and Y. Table 1 shows the results.

### 3) Method of Evaluating Purified Product

The purified products obtained in the Production Examples described above were evaluated in terms of high-molecular-weight body GPC area percent (%), viscosity, and hydroxy value in accordance with the following methods. Table 1 shows the results.

(1) High-Molecular-Weight Body GPC area percent (%)

An area percent (%) of a high-molecular-weight body was calculated for the obtained purified products by GPC measurement under the following conditions.

<GPC Measurement Conditions>
Device: GPC manufactured by Waters Corporation; system name: 1515 2414 717P RI
Detector: RI detector
Column:

Guard column: SHODEX KFG (8 μm, 4.6×10 mm), manufactured by Showa Denko K.K.;

two types of main columns: STYRAGEL HR4E THF (7.8×300 mm)+STYRAGEL HR 1 THF (7.8×300 mm), each manufactured by Waters Corporation
Column temperature: 40° C.
Eluent composition: THF (including 0.03% of sulfur as an internal standard); flow rate: 0.75 mL/minute
Method of calculating the area percent (%) of a high-molecular-weight body

The area percent (%) was calculated based on the GPC measurement results according to the following Equation (1).

Area percent of high-molecular-weight body (%)=[(R−I−L)/R]×100 Equation(1):

Symbols and terms used in Equation (1) are the same as defined above.

(2) Viscosity

Viscosity of the obtained purified product was measured by a type E viscometer (25° C.).

(3) Hydroxy Value

An acetylation reagent is added to the purified product, followed by carrying out heating treatment in a warm bath. After natural cooling, acid titration is performed with a potassium hydroxide ethanol solution using a phenolphthalein solution as an indicator in order to obtain the hydroxy value.

TABLE 1

| | | | | | High molecular | | Hydroxy |
|---|---|---|---|---|---|---|---|
| | | | | Purification | weight body | Viscosity at | value |
| | | Catalyst X | Catalyst Y | yield (%) | GPC area % | 25° C. (mPa · s) | (mgKOH/g) |
| Production | GLY-TA1 | DABCO | Zinc acetate | 90 | 20.0 | 29 | 17 |
| Example 1 | | | | | | | |
| Production | GLY-TA2 | N-methylimidazole | Zinc acrylate | 91 | 18.0 | 28 | 8 |
| Example 2 | | | | | | | |
| Production | GLY-TA3 | DMAP | Zinc | 89 | 20.0 | 30 | 13 |
| Example 3 | | | acetylacetonate | | | | |
| Production | GLY-TA4 | Triphenylphosphine | Zinc acetate | 92 | 18.7 | 27 | 7 |
| Example 4 | | | | | | | |

### 2. Examples and Comparative Examples

### 1) Production of Active Energy Beam-Curable Composition

The compounds listed in Tables 2, 3, 4, and 5 below were stirred and mixed in proportions shown in Tables 2, 3, 4, and 5, thereby producing active energy beam-curable compositions.

Evaluation was conducted as described below using the obtained compositions. Tables 2, 3, 4, and 5 show the results.

Figures in Tables 2 to 5 each represent the number of parts.

Abbreviations used in Tables 2 to 5 each have the following meanings.

<Component (B)>
UA306H: Polyfunctional urethane acrylate (a urethane adduct as a reaction product of pentaerythritol triacrylate and hexamethylene diisocyanate), UA306H, manufactured by Kyoeisha Chemical Co., Ltd.
M1200: Bifunctional urethane acrylate, ARONIX M-1200, manufactured by Toagosei Co., Ltd.
SP1509: Bisphenol A-type epoxy acrylate, RIPOXY SP-1509, manufactured by Showa Denko K.K.
M8100: Polyfunctional polyester acrylate, ARONIX M-8100, manufactured by Toagosei Co., Ltd.; M8100; used herein having a toluene content ratio of 0.1%

<Component (C)>
IRG907:2-Methyl-1-(4-methylthiophenyl)-2-morpholinopropane-1-one, IRGACURE907, manufactured by BASF SE

<Component (E) [Acrylate Other than Components (A) and (B)]>
TMPTA: Trimethylolpropane triacrylate, ARONIX M-309, manufactured by Toagosei Co., Ltd., viscosity of 90 mPa·s at 25° C.
EO-TMPTA: Ethylene oxide (3 mol)-modified trimethylolpropane triacrylate, ARONIX M-350, manufactured by Toagosei Co., Ltd., viscosity of 60 mPa·s at 25° C.
TEGDA: Tetraethylene glycoldiacrylate, ARONIX M-240, manufactured by Toagosei Co., Ltd., viscosity of 20 mPa·s at 25° C.

### 2) Evaluation Method

(1) Properties of Composition

(i) Viscosity

Viscosity of the obtained composition was measured by a type E viscometer (25° C.).

(2) Properties of Cured Product

(ii) Appearance

The obtained compositions were each coated to COSMOSHINE A4300 (thickness of 100 μm) by a bar coater such that a film thickness was adjusted to 5 m.

The obtained test samples were each conveyed and irradiated with ultraviolet ray in a conveyor under air atmosphere, in which the conveyor was adjusted to have irradiation energy of 200 mJ/cm² per pass within a ultraviolet range (UV-A) with a center wavelength of 365 nm at an intensity of 500 mW/cm², using a high-pressure mercury lamp, manufactured by EYE GRAPHICS CO., LTD.

Appearance (in terms of leveling property and cissing) of each obtained cured coating film was visually observed and evaluated according to the following three criteria.

A: Poor leveling or cissing is not observed.

B: Relatively poor leveling or cissing is observed.

C: Poor leveling or cissing is clearly observed.

(iii) Pencil Hardness

Pencil hardness of each cured product obtained in item (ii) was evaluated with a load of 750 g in accordance with JISK5600-5-4.

(iv) Universal Hardness of Cured Product

The obtained compositions were each coated by a bar coater to a 10-cm square glass substrate such that a film thickness was adjusted to 20 m. The glass substrates were each conveyed and irradiated with ultraviolet ray in a conveyor under air atmosphere, in which the conveyor was adjusted to have irradiation energy of 200 mJ/cm² per pass within a ultraviolet range (UV-A) with a center wavelength of 365 nm at intensity of 500 mW/cm², using a high-pressure mercury lamp, manufactured by EYE GRAPHICS CO., LTD.

The obtained cured products were evaluated in terms of hardness using a super-micro hardness tester (H-100C, manufactured by Fischer Instruments K.K.) based on universal hardness obtained when measuring surface hardness under conditions, in which the maximum load of a Vickers indenter is 20 mN at room temperature.

(v) Scratch Resistance

Scratch resistance of each cured product obtained in item (ii) was evaluated according to the following five criteria after applying a load of 500 g using steel wool #0000 by moving the steel wool back and forth for 100 times.

AA: No scratches

A: 1 or more and less than 10 scratches

B: 10 or more and less than 50 scratches

C: 50 or more and less than 100 scratches

D: 100 or more scratches

TABLE 2

| | Composition (parts) | | | | | | | | | Evaluation results | | | | |
|---|---|---|---|---|---|---|---|---|---|---|---|---|---|---|
| | (A) | | | | (E) | | | | | | | | Universal | |
| | GLY- | GLY- | GLY- | GLY- | | EO- | | (B) | (C) | Viscosity | Appear- | Pencil | hardness | Scratch |
| | TA1 | TA2 | TA3 | TA4 | TMPTA | TMPTA | TEGDA | UA306H | IRG907 | (mPa · s) | ance | hardness | (N/mm²) | resistance |
| Example 1 | 25 | | | | | | | 75 | 5 | 2,250 | A | 3H | 308 | AA |
| Example 2 | 50 | | | | | | | 50 | 5 | 380 | A | 3H | 301 | AA |
| Example 3 | | 50 | | | | | | 50 | 5 | 380 | A | 3H | 302 | AA |
| Example 4 | | | 50 | | | | | 50 | 5 | 390 | A | 3H | 301 | AA |
| Example 5 | | | | 50 | | | | 50 | 5 | 380 | A | 3H | 301 | AA |
| Comparative | | | | | | | | 100 | 5 | 18,050 | C | 3H | 318 | AA |
| Example 1 | | | | | | | | | | | | | | |
| Comparative | | | | | 25 | | | 75 | 5 | 4,140 | B | 2H | 298 | A |
| Example 2 | | | | | | | | | | | | | | |
| Comparative | | | | | 50 | | | 50 | 5 | 1,040 | B | 2H | 276 | A |
| Example 3 | | | | | | | | | | | | | | |
| Comparative | | | | | | 25 | | 75 | 5 | 2,880 | A | 2H | 261 | A |
| Example 4 | | | | | | | | | | | | | | |
| Comparative | | | | | | 50 | | 50 | 5 | 600 | A | 2H | 223 | B |
| Example 5 | | | | | | | | | | | | | | |
| Comparative | | | | | | | 25 | 75 | 5 | 1,130 | A | H | 252 | A |
| Example 6 | | | | | | | | | | | | | | |
| Comparative | | | | | | | 50 | 50 | 5 | 170 | A | H | 189 | B |
| Example 7 | | | | | | | | | | | | | | |

The compositions in Examples 1 to 5 and Comparative Examples 1 to 7 each included a urethane adduct as the component (B).

The compositions of the invention in Examples 1 to 5 were found to have low viscosity, and cured products thereof were found to be excellent in terms of appearance, pencil hardness, and universal hardness. The compositions including the urethane adduct were also excellent in terms of scratch resistance.

On the other hand, viscosity of the composition in Comparative Example 1, in which the composition included only a urethane adduct and did not include a component (A), was one-digit greater compared to those of the Examples. In addition, although a cured product thereof was excellent in terms of scratch resistance as well as pencil hardness and universal hardness, the appearance thereof was very poor.

The compositions in Comparative Examples 2 to 7, in which the compositions each included a conventional low-viscosity reactive diluent, were found to have low viscosity. However, cured products thereof were inferior to the compositions of the corresponding Examples not only in terms of any one of appearance, pencil hardness, and universal hardness, but also in terms of scratch resistance.

TABLE 3

| | Composition (parts) | | | | | | | | | Evaluation results | | | | |
|---|---|---|---|---|---|---|---|---|---|---|---|---|---|---|
| | (A) | | | | (E) | | | | | | | | Universal | |
| | GLY- | GLY- | GLY- | GLY- | | EO- | | (B) | (C) | Viscosity | Appear- | Pencil | hardness | Scratch |
| | TA1 | TA2 | TA3 | TA4 | TMPTA | TMPTA | TEGDA | M1200 | IRG907 | (mPa · s) | ance | hardness | (N/mm²) | resistance |
| Example 6 | 50 | | | | | | | 50 | 5 | 3,370 | A | H | 150 | B |
| Example 7 | | 50 | | | | | | 50 | 5 | 3,370 | A | H | 151 | B |
| Example 8 | | | 50 | | | | | 50 | 5 | 3,380 | A | H | 150 | B |
| Example 9 | | | | 50 | | | | 50 | 5 | 3,370 | A | H | 150 | B |
| Comparative | | | | | | | | 100 | 5 | 178,080 | C | 3B | 15 | C |
| Example 8 | | | | | | | | | | (50° C.) | | | | |
| Comparative | | | | | 50 | | | 50 | 5 | 10,740 | B | F | 130 | C |
| Example 9 | | | | | | | | | | | | | | |
| Comparative | | | | | | 50 | | 50 | 5 | 5,390 | A | F | 91 | C |
| Example 10 | | | | | | | | | | | | | | |
| Comparative | | | | | | | 50 | 50 | 5 | 1,090 | A | F | 28 | C |
| Example 11 | | | | | | | | | | | | | | |

The compositions in Examples 6 to 9 and Comparative Examples 8 to 11 each included urethane acrylate as the component (B).

The compositions of the invention in Examples 6 to 9 were found to have low viscosity, and cured products thereof were found to be excellent in terms of appearance, pencil hardness, and universal hardness.

On the other hand, viscosity of the composition in Comparative Example 8, in which the composition included only an acrylic oligomer and did not include a component (A), was two-digit greater compared to those of the Examples at 50° C. In addition, a cured product thereof had very poor appearance, pencil hardness, and universal hardness.

The compositions in Comparative Examples 9 to 11, in which the compositions each included a conventional low-viscosity reactive diluent, were found to have low viscosity. However, cured products thereof were inferior to the compositions in the corresponding Examples in terms of any one of appearance, pencil hardness, and universal hardness.

Further, as a result of examination in terms of scratch resistance, the compositions of the invention in Examples 6 to 9 were evaluated as “C” since the conditions of the evaluation method were stringent, indicating that excellent results may be obtained under usual conditions. On the other hand, the compositions in Comparative Examples 8 to 11 each experienced a decrease in scratch resistance.

TABLE 4

| | Composition (parts) | | | | | | | | | Evaluation results | | | | |
|---|---|---|---|---|---|---|---|---|---|---|---|---|---|---|
| | (A) | | | | (E) | | | | | | | | Universal | |
| | GLY- | GLY- | GLY- | GLY- | | EO- | | (B) | (C) | Viscosity | Appear- | Pencil | hardness | Scratch |
| | TA1 | TA2 | TA3 | TA4 | TMPTA | TMPTA | TEGDA | SP1509 | IRG907 | (mPa · s) | ance | hardness | (N/mm²) | resistance |
| Example 10 | 50 | | | | | | | 50 | 5 | 1,370 | A | H | 240 | B |
| Example 11 | | 50 | | | | | | 50 | 5 | 1,370 | A | H | 241 | B |
| Example 12 | | | 50 | | | | | 50 | 5 | 1,380 | A | H | 240 | B |
| Example 13 | | | | 50 | | | | 50 | 5 | 1,370 | A | H | 240 | B |
| Comparative | | | | | | | | 100 | 5 | 1,530,000 | C | F | 212 | D |
| Example 12 | | | | | | | | | | | | | | |
| Comparative | | | | | 50 | | | 50 | 5 | 4,210 | B | H | 223 | B |
| Example 13 | | | | | | | | | | | | | | |
| Comparative | | | | | | 50 | | 50 | 5 | 2,440 | A | F | 178 | C |
| Example 14 | | | | | | | | | | | | | | |
| Comparative | | | | | | | 50 | 50 | 5 | 540 | A | F | 150 | C |
| Example 15 | | | | | | | | | | | | | | |

The compositions in Examples 10 to 13 and Comparative Examples 12 to 15 each included a polyester acrylate as the component (B).

The compositions of the invention in Examples 10 to 13 were found to have low viscosity, and cured products thereof were found to be excellent in terms of appearance, pencil hardness, and universal hardness.

On the other hand, viscosity of the composition in Comparative Example 12, in which the composition included only an acrylic oligomer and did not include a component (A), was three-digit greater compared to those of the Examples. In addition, a cured product thereof had very poor appearance, pencil hardness, and universal hardness.

In addition, the compositions in Comparative Examples 13 to 15, each including a conventional low-viscosity reactive diluent, were examined.

Viscosity of the composition in Comparative Example 13 was about twice as high as those of the Examples. A cured product thereof was inferior in terms of appearance and relatively inferior in terms of universal hardness to the composition of the corresponding Example. The composition in Comparative Example 14 was found to have viscosity greater than that of the composition in each of the Examples, a cured product thereof was found to have pencil hardness and universal hardness lower than those of the composition in the corresponding Example. Although the composition in Comparative Example 15 was found to have low viscosity, a cured product thereof was found to have pencil hardness and universal hardness lower than those of the composition in the corresponding Example.

Further, as a result of examination in terms of scratch resistance, the compositions of the invention in Examples 10 to 13 were evaluated as “C” since the conditions of the evaluation method were stringent, indicating that excellent results may be obtained under usual conditions. On the other hand, the compositions in Comparative Examples 14 to 15 each experienced a decrease in scratch resistance. Scratch resistance of the composition in Comparative Example 12 was found to be very poor.

TABLE 5

| | Composition (parts) | | | | | | | | | Evaluation results | | | | |
|---|---|---|---|---|---|---|---|---|---|---|---|---|---|---|
| | (A) | | | | (E) | | | | | | | | Universal | |
| | GLY- | GLY- | GLY- | GLY- | | EO- | | (B) | (C) | Viscosity | Appear- | Pencil | hardness | Scratch |
| | TA1 | TA2 | TA3 | TA4 | TMPTA | TMPTA | TEGDA | M8100 | IRG907 | (mPa · s) | ance | hardness | (N/mm²) | resistance |
| Example 14 | 25 | | | | | | | 75 | 5 | 4,100 | A | H | 248 | B |
| Example 15 | 50 | | | | | | | 50 | 5 | 490 | A | H | 254 | B |
| Example 16 | | 50 | | | | | | 50 | 5 | 490 | A | H | 256 | B |
| Example 17 | | | 50 | | | | | 50 | 5 | 500 | A | H | 254 | B |
| Example 18 | | | | 50 | | | | 50 | 5 | 490 | A | H | 254 | B |
| Comparative | | | | | | | | 100 | 5 | 84,900 | C | H | 237 | B |
| Example 16 | | | | | | | | | | | | | | |
| Comparative | | | | | 25 | | | 75 | 5 | 8,460 | B | H | 237 | D |
| Example 17 | | | | | | | | | | | | | | |
| Comparative | | | | | 50 | | | 50 | 5 | 1,490 | A | H | 239 | D |
| Example 18 | | | | | | | | | | | | | | |
| Comparative | | | | | | 25 | | 75 | 5 | 5,400 | A | H | 212 | D |
| Example 19 | | | | | | | | | | | | | | |
| Comparative | | | | | | 50 | | 50 | 5 | 790 | A | H | 184 | D |
| Example 20 | | | | | | | | | | | | | | |
| Comparative | | | | | | | 25 | 75 | 5 | 1,840 | A | H | 192 | D |
| Example 21 | | | | | | | | | | | | | | |
| Comparative | | | | | | | 50 | 50 | 5 | 200 | A | H | 161 | D |
| Example 22 | | | | | | | | | | | | | | |

The compositions in Examples 14 to 18 and Comparative Examples 16 to 22 each included an epoxy acrylate as the component (B).

The compositions of the invention in Examples 14 to 18 were found to have low viscosity, and cured products thereof were found to be excellent in terms of appearance, pencil hardness, and universal hardness.

On the other hand, viscosity of the composition in Comparative Example 16, in which the composition included only an acrylic oligomer and did not include a component (A), was one-digit greater compared to those of the Examples. In addition, a cured product thereof had low universal hardness and very poor appearance.

In addition, the compositions in Comparative Examples 16 to 22, each including a conventional low-viscosity reactive diluent, were examined. Viscosity of the composition in Comparative Example 17 was about twice as high as those of the Examples. A cured product thereof was inferior in terms of appearance to the composition of the corresponding Example. Although the compositions in Comparative Examples 18 to 22 were found to have low viscosity, cured products thereof were found to have universal hardness lower than that of the compositions in the corresponding Examples.

Further, as a result of examination in terms of scratch resistance, the compositions of the invention in Examples 14 to 18 were evaluated as “C” since the conditions of the evaluation method were stringent, indicating that excellent results may be obtained under usual conditions. On the other hand, the compositions in Comparative Examples 17 to 22 each had very poor scratch resistance.

### INDUSTRIAL APPLICABILITY

The composition of the invention can be used for various purposes. The composition can be preferably used as coating agents, ink, molding material, or the like, and particularly preferably used for coating, such as plastic paints or wood paints.

1. A curable composition, comprising the following components (A) and (B),
component (A): a (meth)acrylate mixture comprising glycerin tri(meth)acrylate as a main component, the mixture comprising a high-molecular-weight body, for which an area percent (%) is defined by the following Equation (1) and is a value obtained in accordance with gel permeation chromatography measurement, is less than 30%:
Area percent of high-molecular-weight body (%)=[(R−I−L)/R]×100 Equation (1):
wherein symbols and terms in Equation (1) each have the following meanings,
R: Total area of detection peaks in the component (A),
I: Area of detection peaks comprising glycerin tri(meth)acrylate,
L: Total area of detection peaks for a weight-average molecular weight smaller than that for detection peaks comprising glycerin tri(meth)acrylate; and
component (B): an oligomer having two or more (meth)acryloyl groups, a reaction product of an organic polyisocyanate and a hydroxy group-containing (meth)acrylate, or a combination thereof.

2. The curable composition according to claim 1, wherein the component (A) is a (meth)acrylate mixture comprising glycerin tri(meth)acrylate as a main component, which is obtained by carrying out transesterification of glycerin and a compound having one (meth)acryloyl group.

3. The curable composition according to claim 2, wherein the component (A) is a (meth)acrylate mixture comprising glycerin tri(meth)acrylate as a main component, which is obtained by carrying out transesterification of glycerin and a compound having one (meth)acryloyl group under the presence of the following catalysts X and Y,
catalyst X: at least one compound selected from the group consisting of a cyclic tertiary amine having an azabicyclo structure or a salt or complex thereof, an amidine or a salt or complex thereof, a compound having a pyridine ring or a salt or complex thereof, and a phosphine or a salt or complex thereof; and
catalyst Y: a compound comprising zinc.

4. The curable composition according to claim 3, wherein the catalyst X is the following compound,
catalyst X: at least one compound selected from the group consisting of a cyclic tertiary amine having an azabicyclo structure or a salt or complex thereof, an amidine or a salt or complex thereof, and a compound having a pyridine ring or a salt or complex thereof.

5. The curable composition according to claim 2, wherein the compound having one (meth)acryloyl group is an alkoxyalkyl(meth)acrylate.

6. The curable composition according to claim 3, wherein the catalyst Y is an organic acid zinc, a zinc diketone enolate, or a combination thereof.

7. The curable composition according to claim 1, wherein the component (A) has a hydroxy value of 60 mg KOH/g or less.

8. The curable composition according to claim 1, wherein the oligomer having two or more (meth)acryloyl groups of the component (B) comprises at least one selected from the group consisting of a urethane (meth)acrylate, an epoxy(meth)acrylate, and a polyester(meth)acrylate.

9. The curable composition according to claim 1, wherein a content of the component (A) is from 10% to 70% by weight and a content of the component (B) is from 30% to 90% by weight, with respect to 100% by weight in total of the components (A) and (B).

10. An active energy beam-curable composition, comprising the composition according to claim 1.

11. The active energy beam-curable composition according to claim 10, further comprising a photopolymerization initiator (C).

12. An active energy beam-curable composition for coating, comprising the composition according to claim 10.

13. An active energy beam-curable composition for plastic paints, comprising the composition according to claim 12.

14. An active energy beam-curable composition for wood paints, comprising the composition according to claim 12.

15. A method of producing a curable composition, comprising:
producing a (meth)acrylate mixture (A) comprising glycerin tri(meth)acrylate as a main component, which is obtained by carrying out transesterification of glycerin and a compound having one (meth)acryloyl group under the presence of the following catalysts X and Y; and
stirring and mixing the obtained component (A) and the following component (B),
catalyst X: at least one compound selected from the group consisting of a cyclic tertiary amine having an azabicyclo structure or a salt or complex thereof, an amidine or a salt or complex thereof, a compound having a pyridine ring or a salt or complex thereof, and a phosphine or a salt or complex thereof;
catalyst Y: a compound comprising zinc; and
component (B): an oligomer having two or more (meth)acryloyl groups, a reaction product of an organic polyisocyanate and a hydroxy group-containing (meth)acrylate, or a combination thereof.

16. The method of producing a curable composition according to claim 15, wherein the compound having one (meth)acryloyl group is an alkoxyalkyl(meth)acrylate.

17. The method of producing a curable composition according to claim 15, wherein the catalyst X is at least one compound selected from the group consisting of a cyclic tertiary amine having an azabicyclo structure or a salt or complex thereof, an amidine or a salt or complex thereof, and a compound having a pyridine ring or a salt or complex thereof.

18. The method of producing a curable composition according to claim 15, wherein the catalyst Y is an organic acid zinc, a zinc diketone enolate, or a combination thereof.

19. The method of producing a curable composition according to claim 15, comprising, after producing the component (A), mixing a photopolymerization initiator (C) therein.
